(19) United States
(12) Patent Application Publication
(10) Pub. No.: US 2022/0038734 A1
(43) Pub. Date: Feb. 3, 2022

(54) METHOD AND DEVICE FOR PROCESSING IMAGE SIGNAL

(71) Applicant: LG ELECTRONICS INC., Seoul (KR)

(72) Inventors: Jaeho LEE, Seoul (KR); Junghak NAM, Seoul (KR); Naeri PARK, Seoul (KR); Jaehyun LIM, Seoul (KR); Hyeongmoon JANG, Seoul (KR)

(21) Appl. No.: 17/278,481

(22) PCT Filed: Sep. 20, 2019
(86) PCT No.: PCT/KR2019/012273

§ 371 Date: Mar. 22, 2021

Related U.S. Application Data
(60) Provisional application No. 62/734,244, filed on Sep. 20, 2018.
(60) Provisional application No. 62/734,248, filed on Sep. 20, 2018.

(51) Int. Cl. H04N 19/513; H04N 19/105; H04N 19/132; H04N 19/176

(52) U.S. Cl. CPC H04N 19/513; H04N 19/176; H04N 19/132; H04N 19/105

(57) ABSTRACT

Embodiments of the present specification provide a method and a device for processing a video signal. A method for processing an image signal, according to an embodiment of the present specification, comprises the steps of: generating a merge candidate list including a first motion vector and a second motion vector from a spatial merge candidate or a temporal merge candidate of a current block; adding, to the merge candidate list, a third motion vector determined as the average value of the first motion vector and the second motion vector, if the number of merge candidates of the merge candidate list is smaller than the maximum number of merge candidates; and generating a prediction sample of the current block by using a motion vector indicated by a merge index in the merge candidate list.

### TECHNICAL FIELD

The present disclosure relates to a method and device for processing an image signal, and more particularly, to a method and device for encoding or decoding an image signal using prediction.

### BACKGROUND ART

Compression encoding means a series of signal processing techniques for transmitting digitized information through a communication line or techniques for storing information in a form suitable for a storage medium. The medium including a picture, an image, audio, etc. may be a target for compression encoding, and particularly, a technique for performing compression encoding on a picture is referred to as video image compression.

Next-generation video contents are supposed to have the characteristics of high spatial resolution, a high frame rate and high dimensionality of scene representation. In order to process such contents, a drastic increase in the memory storage, memory access rate and processing power will result.

Accordingly, it is required to design a coding tool for processing next-generation video contents efficiently. In particular, a video codec standard after the high efficiency video coding (HEVC) standard requires a prediction technology capable of accurately generating a prediction sample, while more efficiently using resources.

### DISCLOSURE

### Technical Problem

Embodiments of the present disclosure provide a method and apparatus for efficiently constructing a merge candidate list in inter prediction that predicts a current picture using another picture.

Technical objects to be achieved by the present disclosure are not limited to the aforementioned technical objects, and other technical objects not described above may be evidently understood by a person having ordinary skill in the art to which the present disclosure pertains from the following description.

### Technical Solution

In an aspect, a method of decoding an image signal, the method includes: generating a merge candidate list including a plurality of motion vectors derived from a spatial merge candidate or a temporal merge candidate of a current block; adding an additional motion vector determined as an average value of the motion vectors to the merge candidate list when a number of merge candidates of the merge candidate list is smaller than a maximum number of merge candidates; and generating a prediction sample of the current block using a motion vector indicated by a merge index on the merge candidate list.

The adding of the additional motion vector to the merge candidate list may include

adding, as the additional motion vector, an average value of a first motion vector corresponding to a first index and a second motion vector corresponding to a second index to the merge candidate list.

The generating of the merge candidate list may include: performing searching on a motion vector for the temporal merge candidate after searching a motion vector for the spatial merge candidate.

The searching of the motion vector for the spatial merge candidate may be performed in order of a left block, an upper block, an upper right block, a lower left block, and an upper left block of the current block.

The method may further include: adding a zero motion vector to the merge candidate list when the number of merge candidates of the merge candidate list to which the additional motion vector is added is smaller than the maximum number of merge candidates.

The motion vectors may refer to the same reference picture.

The additional motion vector may refer to the reference picture equally referred to by the motion vectors.

In another aspect, an apparatus for decoding an image signal may include: a memory configured to store the image signal; and a processor coupled to the memory, wherein the processor is configured to generate a merge candidate list including a plurality of motion vectors derived from a spatial merge candidate or a temporal merge candidate of a current block, to add an additional motion vector determined as an average value of the motion vectors to the merge candidate list when a number of merge candidates of the merge candidate list is smaller than a maximum number of merge candidates, and to generate a prediction sample of the current block using a motion vector indicated by a merge index on the merge candidate list.

### Advantageous Effects

According to an embodiment of the present disclosure, coding efficiency may be improved without increasing coding complexity by constructing a merge candidate list including an additional merge candidate generated from a combination of existing merge candidates.

Effects which may be obtained by the present disclosure are not limited to the aforementioned effects, and other technical effects not described above may be evidently understood by a person having ordinary skill in the art to which the present disclosure pertains from the following description.

### DESCRIPTION OF DRAWINGS

The accompany drawings, which are included to provide a further understanding of the present disclosure and are incorporated on and constitute a part of this specification illustrate embodiments of the present disclosure and together with the description serve to explain the principles of the present disclosure.

FIG. 1 shows an example of a video coding system according to an embodiment of the present disclosure.

FIG. 2 is a schematic block diagram of an encoding apparatus of encoding a video/image signal as an embodiment to which the present disclosure is applied.

FIG. 3 is a schematic block diagram of a decoding apparatus of decoding an image signal as an embodiment to which the present disclosure is applied.

FIG. 4 is a structural diagram of a content streaming system according to an embodiment to which the present disclosure is applied.

FIG. 5 shows an example of a picture divided into coding tree units (CTUs).

FIG. 6 shows an example of multi-type tree splitting modes according to an embodiment of the present disclosure.

FIG. 7 shows an example of a signaling mechanism of partitioning information in a quadtree with nested multi-type tree structure.

FIG. 8 exemplarily shows that a CTU is split into multiple coding units (CUs) based on a quadtree and a nested multi-type tree structure.

FIG. 9 shows an example in which ternary tree (TT) splitting is restricted for a 128×128 coding block.

FIG. 10 exemplarily shows redundant partitioning patterns that may occur in binary tree partitioning and ternary tree partitioning.

FIGS. 11 and 12 illustrate a video/image encoding procedure based on inter prediction and an inter predictor in an encoding apparatus.

FIGS. 13 and 14 illustrate a video/image decoding procedure based on inter prediction and an inter predictor in a decoding apparatus.

FIG. 15 shows an example of a configuration of a spatial merge candidate for a current block.

FIG. 16 shows an example of a flowchart for constructing a merge candidate list according to an embodiment of the present disclosure.

FIG. 17 shows an example of a method of performing adaptive temporal motion vector prediction (ATMVP).

FIG. 18 shows an example of a flowchart for constructing a prediction candidate list (MVP candidate list).

FIGS. 19 and 20 illustrate an example of a method of constructing a merge candidate list.

FIG. 21 illustrates another example of a method of constructing a merge candidate list according to an embodiment of the present disclosure.

FIG. 22 illustrates another example of a method of constructing a merge candidate list according to an embodiment of the present disclosure.

FIG. 23 illustrates another example of a method of constructing a merge candidate list according to an embodiment of the present disclosure.

FIG. 24 shows an example of a flowchart for performing prediction according to an embodiment of the present disclosure.

FIG. 25 illustrates an example of a block diagram of an apparatus for processing an image signal according to an embodiment of the present disclosure.

FIG. 26 is a diagram schematically showing an example of a service system including a digital device.

FIG. 27 is a block diagram illustrating a configuration of a digital device according to an embodiment.

FIG. 28 is a block diagram illustrating a configuration of a digital device according to another embodiment.

FIG. 29 is a block diagram illustrating a configuration of a digital device according to another embodiment.

FIG. 30 is a block diagram illustrating a detailed configuration of a controller of FIGS. 27 to 29 according to an embodiment.

FIG. 31 is a diagram illustrating an example in which a screen of a digital device according to an embodiment displays a main image and a sub-image at the same time.

### MODE FOR DISCLOSURE

Hereinafter, preferred embodiments of the disclosure will be described by reference to the accompanying drawings. The description that will be described below with the accompanying drawings is to describe embodiments of the disclosure, and is not intended to describe the only embodiment in which the disclosure may be implemented. The description below includes particular details in order to provide perfect understanding of the disclosure. However, it is understood that the disclosure may be embodied without the particular details to those skilled in the art.

In some cases, in order to prevent the technical concept of the disclosure from being unclear, structures or devices which are publicly known may be omitted, or may be depicted as a block diagram centering on the core functions of the structures or the devices.

Further, although general terms widely used currently are selected as the terms in the disclosure as much as possible, a term that is arbitrarily selected by the applicant is used in a specific case. Since the meaning of the term will be clearly described in the corresponding part of the description in such a case, it is understood that the disclosure will not be simply interpreted by the terms only used in the description of the disclosure, but the meaning of the terms should be figured out.

Specific terminologies used in the description below may be provided to help the understanding of the disclosure. Furthermore, the specific terminology may be modified into other forms within the scope of the technical concept of the disclosure. For example, a signal, data, a sample, a picture, a frame, a block, etc may be properly replaced and interpreted in each coding process.

In the present disclosure, a ‘processing unit’ refers to a unit on which encoding/decoding process such as prediction, transform and/or quantization is performed. The processing unit may also be interpreted as the meaning including a unit for a luma component and a unit for a chroma component. For example, the processing unit may correspond to a block, a coding unit (CU), a prediction unit (PU) or a transform unit (TU).

The processing unit may also be interpreted as a unit for a luma component or a unit for a chroma component. For example, the processing unit may correspond to a coding tree block (CTB), a coding block (CB), a prediction unit (PU) or a transform block (TB) for the luma component. Alternatively, the processing unit may correspond to a CTB, a CB, a PU or a TB for the chroma component. The processing unit is not limited thereto and may be interpreted as the meaning including a unit for the luma component and a unit for the chroma component.

In addition, the processing unit is not necessarily limited to a square block and may be configured in a polygonal shape having three or more vertexes.

Hereinafter, in the present disclosure, a pixel or a coefficient (a transform coefficient or a transform coefficient which has undergone a first transformation) and the like are collectively referred to as a sample. In addition, using a sample may refer to using a pixel value or a coefficient (a transform coefficient or a transform coefficient which has undergone the first transformation).

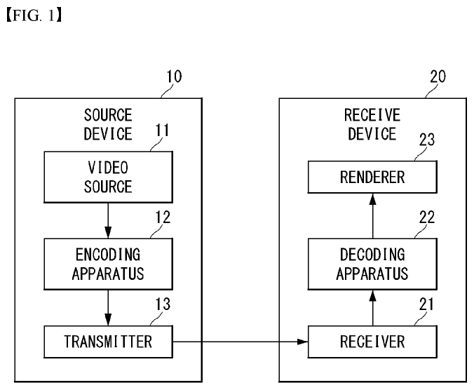

FIG. 1 shows an example of a video coding system according to an embodiment of the present disclosure.

The video coding system may include a source device 10 and a receiving device 20. The source device 10 may transfer encoded video/image information or data to the receiving device 20 through a digital storage medium or network in a file or streaming form.

The source device 10 may include a video source 11, an encoding apparatus 12, and a transmitter 13. The receive device 20 may include a receiver, a decoding apparatus 22 and a renderer 23. The encoding apparatus 12 may be called a video/image encoding apparatus and the decoding apparatus 20 may be called a video/image decoding apparatus. The transmitter 13 may be included in the encoding apparatus 12. The receiver 21 may be included in the decoding apparatus 22. The renderer 23 may include a display and the display may be configured as a separate device or an external component.

A video source may acquire a video/image through a capturing, synthesizing, or generating process of the video/image. The video source may include a video/image capture device and/or a video/image generation device. The video/image capture device may include, for example, one or more cameras, video/image archives including previously captured video/images, and the like. The video/image generation device may include, for example, a computer, a tablet, and a smart phone and may (electronically) generate the video/image. For example, a virtual video/image may be generated by the computer, etc., and in this case, the video/image capturing process may be replaced by a process of generating related data.

The encoding apparatus 12 may encode an input video/image. The encoding apparatus 12 may perform a series of procedures including prediction, transform, quantization, and the like for compression and coding efficiency. The encoded data (encoded video/image information) may be output in the bitstream form.

The transmitter 13 may transfer the encoded video/image information or data output in the bitstream to the receiver of the receiving device through the digital storage medium or network in the file or streaming form. The digital storage medium may include various storage media such as universal serial bus (USB), secure digital (SD), compact disk (CD), digital video disk (DVD), Blu-ray, hard disk drive (HDD), solid state drive (SSD), and the like. The transmitter 13 may include an element for generating a media file through a predetermined file format and may include an element for transmission through a broadcast/communication network. The receiver 21 may extract the bitstream and transfer the extracted bitstream to the decoding apparatus 22.

The decoding apparatus 22 performs a series of procedures including dequantization, inverse transform, prediction, etc., corresponding to an operation of the encoding apparatus 12 to decode the video/image.

The renderer 23 may render the decoded video/image. The rendered video/image may be displayed by the display unit.

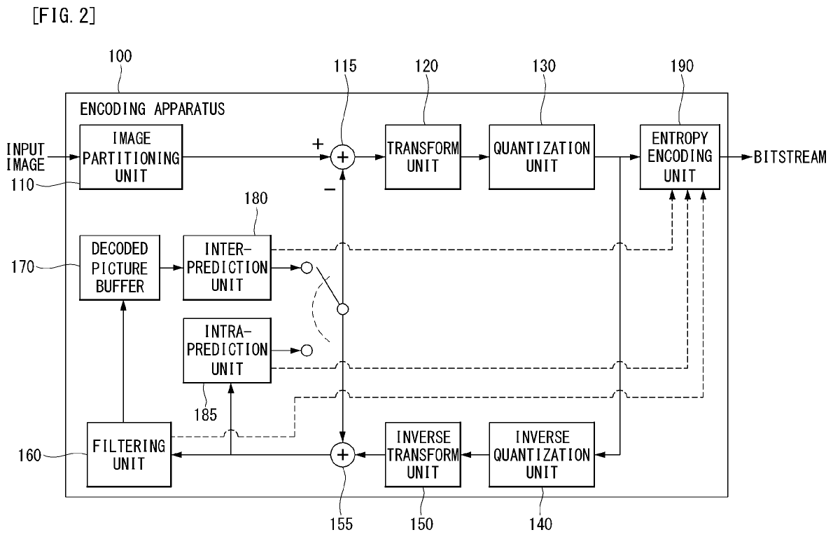

FIG. 2 is a schematic block diagram of an encoding apparatus of encoding a video/image signal, as an embodiment of the present disclosure. An encoding apparatus 100 of FIG. 2 may correspond to the encoding apparatus 12 of FIG. 1.

Referring to FIG. 2, the encoding apparatus 100 may include an image partitioner 110, a subtractor 115, a transformer 120, a quantizer 130, a dequantizer 140, an inverse transformer 150, an adder 155, a filter 160, a decoded picture buffer (DPB) 170, an inter predictor 180, an intra predictor 185, and an entropy encoder 190. The inter predictor 180 and the intra predictor 185 may be collectively referred to as a predictor. That is, the predictor may include the inter predictor 180 and the intra predictor 185. The transformer 120, the quantizer 130, the dequantizer 140, and the inverse transformer 150 may be included in a residual processor. The residual processor may further include a subtractor 115. The aforementioned image partitioner 110, subtractor 115, transformer 120, quantizer 130, dequantizer 140, inverse transformer 150, adder 155, filter 160, inter predictor 180, intra predictor 185, and entropy encoder 190 may be configured by one hardware component (e.g., an encoder or a processor) according to an embodiment. In addition, the DPB 170 may be configured by one hardware component (e.g., a memory or a digital storage medium) according to an embodiment.

The image partitioning unit 110 may partition an input image (or picture or frame) input to the encoding apparatus 100 into one or more processing units. For example, the processing unit may be called a coding unit (CU). In this case, the coding unit may be recursively split from a coding tree unit (CTU) or a largest coding unit (LCU) based on a quadtree binary tree (QTBT) structure. For example, one coding unit may be partitioned into a plurality of coding units of deeper depth based on a quadtree structure and/or a binary tree structure. In this case, for example, the quadtree structure may be first applied, and the binary tree structure may be then applied. Alternatively the binary tree structure may be first applied. A coding procedure according to the present disclosure may be performed based on a final coding unit that is no longer partitioned. In this case, the largest coding unit may be directly used as the final coding unit based on coding efficiency according to image characteristics, or the coding unit may be recursively split into coding units of deeper depth, if necessary or desired, and thus a coding unit with an optimal size may be used as the final coding unit. Herein, the coding procedure may include a procedure, such as prediction, transform or reconstruction to be described later. As another example, the processing unit may further include a prediction unit (PU) or a transform unit (TU). In this case, each of the prediction unit and the transform unit may be split or partitioned from the final coding unit described above. The prediction unit may be a unit for sample prediction, and the transform unit may be a unit from which a transform coefficient is derived and/or a unit in which a residual signal is derived from a transform coefficient.

A unit may be interchangeably used with terms such as a block or an area, if necessary or desired. In a common case, an M×N block may indicate a set of samples consisting of M columns and N rows or a set of transform coefficients. The sample may generally indicate a pixel or a value of a pixel, and may indicate only a pixel/pixel value of a luma component or only a pixel/pixel value of a chroma component. In the sample, one picture (or image) may be used as a term corresponding to a pixel or pel.

The encoding apparatus 100 may subtract a prediction signal (predicted block or prediction sample array) output by the inter-prediction unit 180 or the intra-predictor 185 from an input image signal (original block or original sample array) to generate a residual signal (residual block or residual sample array), and the generated residual signal is sent to the transformer 120. In this case, as illustrated, in the encoding apparatus 100, a unit that subtracts the prediction signal (predicted block or prediction sample array) from the input image signal (original block or original sample array) may be called the subtractor 115. The prediction unit may perform prediction for a processing target block (hereinafter referred to as a current block), and may generate a predicted block including prediction samples for the current block. The prediction unit may determine whether intra-prediction or inter-prediction is applied on a per current block or CU basis. The prediction unit may generate a variety of information on prediction, such as prediction mode information as will be described later in the description of each prediction mode, and may transmit the variety of information to the entropy encoder 190. The information on the prediction may be encoded by the entropy encoder 190 and may be output in the form of bitstream.

The intra-predictor 185 can predict a current block with reference to samples in a current picture. Referred samples may neighbor the current block or may be separated therefrom according to a prediction mode. In intra-prediction, prediction modes may include a plurality of nondirectional modes and a plurality of directional modes. The nondirectional modes may include a DC mode and a planar mode, for example. The directional modes may include, for example, 33 directional prediction modes or 65 directional prediction modes according to a degree of minuteness of prediction direction. However, this is exemplary and a number of directional prediction modes equal to or greater than 65 or equal to or less than 33 may be used according to settings. The intra-predictor 185 may determine a prediction mode to be applied to the current block using a prediction mode applied to neighbor blocks.

The inter-prediction unit 180 may derive a prediction block for the current block based on a reference block (reference sample array) specified by a motion vector on the reference picture. In this case, in order to reduce an amount of motion information transmitted in the inter-prediction mode, the motion information may be predicted in units of a block, a subblock, or a sample based on a correlation of the motion information between the neighboring block and the current block. The motion information may include a motion vector and a reference picture index. The motion information may further include inter-prediction direction (L0 prediction, L1 prediction, Bi prediction, etc.) information. In the case of the inter prediction, the neighboring block may include a spatial neighboring block which is present in the current picture and a temporal neighboring block which is present in the reference picture. A reference picture including the reference block and a reference picture including the temporal neighboring block may be the same as each other or different from each other. The temporal neighboring block may be referred to as a name such as a collocated reference block, a collocated CU (colCU), etc., and the reference picture including the temporal neighboring block may be referred to as a collocated picture (colPic). For example, the inter-prediction unit 180 may configure a motion information candidate list based on the neighboring blocks and generate information indicating which candidate is used in order to derive the motion vector and/or the reference picture index of the current block. The inter prediction may be performed based on various prediction modes and for example, in the case of a skip mode and a merge mode, the inter-prediction unit 180 may use the motion information of the neighboring block as the motion information of the current block. In the case of the skip mode, the residual signal may not be transmitted unlike the merge mode. In the case of a motion vector prediction (MVP) mode, the motion vector of the neighboring block is used as a motion vector predictor and a motion vector difference is signaled to indicate the motion vector of the current block.

A prediction signal generated through the inter-prediction unit 180 or the intra-predictor 185 may be used to generate a reconstructed signal or to generate a residual signal.

The transformer 120 may generate transform coefficients by applying a transform scheme to a residual signal. For example, the transform scheme may include at least one of a discrete cosine transform (DCT), a discrete sine transform (DST), a Karhunen-Loève transform (KLT), a graph-based transform (GBT), or a conditionally non-linear transform (CNT). The GBT means a transform obtained from a graph if relation information between pixels is represented by the graph. The CNT means a transform obtained based on a prediction signal generated using all previously reconstructed pixels. Furthermore, a transform process may be applied to pixel blocks with the same size in a square shape, or may be applied to blocks with variable sizes in a non-square shape.

A quantizer 130 may quantize transform coefficients and transmit the quantized transform coefficients to the entropy encoder 190, and the entropy encoder 190 may encode a quantized signal (information on the quantized transform coefficients) and output the encoded signal as a bitstream. The information on the quantized transform coefficients may be called residual information. The quantizer 130 may rearrange the quantized transform coefficients in the form of a block into the form of a one-dimensional vector on the basis of a coefficient scan order and generate information on the quantized transform coefficients on the basis of the quantized transform coefficients in the form of a one-dimensional vector. The entropy encoder 190 can execute various encoding methods such as exponential Golomb, CAVLC (context-adaptive variable length coding) and CABAC (context-adaptive binary arithmetic coding), for example. The entropy encoder 190 may encode information necessary for video/image reconstruction (e.g., values of syntax elements and the like) along with or separately from the quantized transform coefficients. Encoded information (e.g., video/image information) may be transmitted or stored in the form of a bitstream in network abstraction layer (NAL) unit. The bitstream may be transmitted through a network or stored in a digital storage medium. Here, the network may include a broadcast network and/or a communication network and the digital storage medium may include various storage media such as a USB, an SD, a CD, a DVD, Blu-ray, an HDD and an SSD. A transmitter (not shown) which transmits the signal output from the entropy encoder 190 and/or a storage (not shown) which stores the signal may be configured as internal/external elements of the encoding apparatus 100, and the transmitter may be a component of the entropy encoder 190.

The quantized transform coefficients output from the quantizer 130 may be used to generate the prediction signal. For example, dequantization and inverse transform may be applied to the quantized transform coefficients by the dequantizer 140 and the inverse transformer 150 in a loop to reconstruct the residual signal. The adder 155 adds the reconstructed residual signal to the prediction signal output from the inter-prediction unit 180 or the intra-predictor 185 to generate a reconstructed signal (a reconstructed picture, a reconstructed block, or a reconstructed sample array). Like the case of applying the skip mode, when there is no residual for the processing target block, the prediction block may be used as the reconstructed block. The adder 155 may be referred to as a reconstruction unit or a reconstructed block generation unit. The generated reconstructed signal may be used for intra prediction of a next processing target block in the current picture and may be used for inter prediction of a next picture through filtering as described below.

A filter 160 can improve subjective/objective picture quality by applying filtering to the reconstructed signal. For example, the filter 160 can generate a modified reconstructed picture by applying various filtering methods to the reconstructed picture and transmit the modified reconstructed picture to a decoded picture buffer 170. The various filtering methods may include, for example, deblocking filtering, sample adaptive offset, adaptive loop filtering, and bilateral filtering. The filter 160 can generate various types of information on filtering and transmit the information to the entropy encoder 190 as will be described later in description of each filtering method. Information on filtering may be encoded in the entropy encoder 190 and output in the form of a bitstream.

The modified reconstructed picture transmitted to the decoded picture buffer 170 can be used as a reference picture in the inter-prediction unit 180. Accordingly, the encoding apparatus can avoid mismatch between the encoding apparatus 100 and the decoding apparatus and improve encoding efficiency when inter-prediction is applied.

The decoded picture buffer 170 can store the modified reconstructed picture such that the modified reconstructed picture is used as a reference picture in the inter-prediction unit 180.

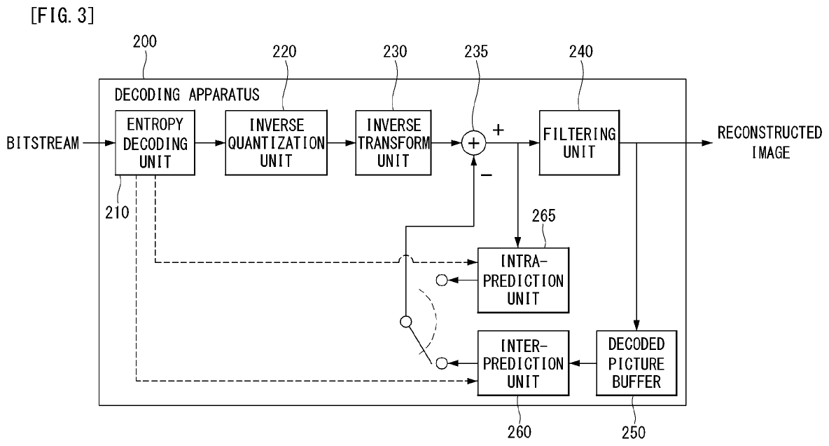

FIG. 3 is a schematic block diagram of a decoding apparatus which performs decoding of a video signal as an embodiment of the present disclosure. The decoding apparatus 200 of FIG. 3 corresponds to the decoding apparatus 22 of FIG. 1.

Referring to FIG. 3, the decoding apparatus 200 may include an entropy decoding unit 210, a dequantizer 220, an inverse transformer 230, an adder 235, a filter 240, a decoded picture buffer (DPB) 250, an inter-prediction unit 260, and an intra-prediction unit 265. The inter-prediction unit 260 and the intra-prediction unit 265 may be collectively called a predictor. That is, the predictor can include the inter-prediction unit 180 and the intra-predictor 185. The dequantizer 220 and the inverse transformer 230 may be collectively called a residual processor. That is, the residual processor can include the dequantizer 220 and the inverse transformer 230. The aforementioned entropy decoding unit 210, dequantizer 220, inverse transformer 230, adder 235, filter 240, inter-prediction unit 260 and intra-prediction unit 265 may be configured as a single hardware component (e.g., a decoder or a processor) according to an embodiment. Further, the decoded picture buffer 250 may be configured as a single hardware component (e.g., a memory or a digital storage medium) according to an embodiment.

If a bitstream including video/image information is input, the decoding apparatus 200 may reconstruct an image according to a process of processing video/image information in the encoding apparatus 100 of FIG. 1. For example, the decoding apparatus 200 may perform decoding using the processing unit applied in the encoding apparatus 100. Thus, a processing unit for decoding may be, for example, a coding unit, and the coding unit may be split from a coding tree unit or a largest coding unit depending on a quadtree structure and/or a binary-tree structure. Further, a reconstructed image signal decoded and output by the decoding apparatus 200 may be reproduced through a playback device.

The decoding apparatus 200 may receive a signal output by the encoding apparatus 100 of FIG. 1 in the form of bitstream, and the received signal may be decoded through the entropy decoding unit 210. For example, the entropy decoding unit 210 may parse the bitstream to derive information (e.g., video/image information) necessary for image reconstruction (or picture reconstruction). For example, the entropy decoding unit 210 may decode information within the bitstream based on a coding method such as exponential Golomb coding, CAVLC or CABAC, and may output a value of a syntax element necessary for image reconstruction or quantized values of transform coefficients about a residual. More specifically, a CABAC entropy decoding method may receive a bin corresponding to each syntax element from a bitstream, determine a context model using decoding target syntax element information and decoding information of a neighboring and decoding target block or information of a symbol/bin decoded in a previous step, predict a probability of occurrence of the bin based on the determined context model, and perform arithmetic decoding of the bin to thereby generate a symbol corresponding to a value of each syntax element. In this instance, the CABAC entropy decoding method may determine a context model, and then update the context model using information of a symbol/bin decoded for a context model of a next symbol/bin. Information related to a prediction among information decoded in the entropy decoding unit 210 may be provided to the prediction unit (the inter-prediction unit 260 and the intra-prediction unit 265). A residual value, i.e., quantized transform coefficients and related parameter information, on which entropy decoding is performed in the entropy decoding unit 210, may be input to the dequantizer 220. Further, information related to filtering among information decoded in the entropy decoding unit 210 may be provided to the filter 240. A receiver (not shown) receiving a signal output from the encoding apparatus 100 may be further configured as an internal/external element of the decoding apparatus 200, or the receiver may be a component of the entropy decoding unit 210.

The dequantizer 220 can inversely quantize the quantized transform coefficients to output transform coefficients. The dequantizer 220 can rearrange the quantized transform coefficients in the form of a two-dimensional block. In this case, rearrangement can be performed on the basis of the coefficient scan order in the encoding apparatus 100. The dequantizer 220 can perform inverse quantization on the quantized transform coefficients using a quantization parameter (e.g., quantization step size information) and acquire transform coefficients.

The inverse transformer 230 inversely transforms the transform coefficients to obtain a residual signal (residual block or residual sample array).

The predictor can perform prediction on a current block and generate a predicted block including predicted samples with respect to the current block. The predictor ca determine whether intra-prediction or inter-prediction is applied to the current block on the basis of the information on prediction output from the entropy decoding unit 210 and determine a specific intra/inter-prediction mode.

The intra-prediction unit 265 can predict the current block with reference to samples in a current picture. The referred samples may neighbor the current block or may be separated from the current block according to an prediction mode. In intra-prediction, prediction modes may include a plurality of nondirectional modes and a plurality of directional modes. The intra-prediction 265 may determine a prediction mode applied to the current block using a prediction mode applied to neighboring blocks.

The inter-prediction unit 260 may derive a predicted block for a current block based on a reference block (reference sample array) that is specified by a motion vector on a reference picture. In this instance, in order to reduce an amount of motion information transmitted in an inter-prediction mode, motion information may be predicted on a per block, subblock or sample basis based on a correlation of motion information between a neighboring block and the current block. The motion information may include a motion vector and a reference picture index. The motion information may further include inter-prediction direction (L0 prediction, L1 prediction, Bi prediction, etc.) information. In the case of inter-prediction, the neighboring block may include a spatial neighboring block present in a current picture and a temporal neighboring block present in a reference picture. For example, the inter-prediction unit 260 may construct a motion information candidate list based on neighboring blocks, and may derive a motion vector and/or reference picture index of the current block based on received candidate selection information. The inter-prediction may be performed based on various prediction modes. Information related to the prediction may include information indicating a mode of inter-prediction for the current block.

The adder 235 adds the obtained residual signal to a predicted signal (a prediction block or a predicted sample array) output from the inter-prediction unit 260 or the intra-prediction unit 265 to generate a reconstructed signal (a reconstructed picture, a reconstructed block, or a reconstructed sample array). Like the case of applying the skip mode, when there is no residual for the processing target block, the prediction block may be used as the reconstructed block.

The adder 235 may be referred to as a reconstruction unit or a reconstructed block generation unit. The generated reconstructed signal may be used for intra prediction of a next processing target block in the current picture and used for inter prediction of a next picture through a filtering as described below.

The filter 240 can improve subjective/objective picture quality by applying filtering to the reconstructed signal. For example, the filter 240 can generate a modified reconstructed picture by applying various filtering methods to the reconstructed picture and transmit the modified reconstructed picture to a decoded picture buffer 250. The various filtering methods may include, for example, deblocking filtering, sample adaptive offset (SAO), adaptive loop filtering (ALF), and bilateral filtering.

The modified reconstructed picture transmitted to the decoded picture buffer 250 can be used as a reference picture by the inter-prediction unit 260.

In the present description, embodiments described in the filter 160, the inter-prediction unit 180 and the intra-predictor 185 of the encoding apparatus 100 can be applied to the filter 240, the inter-prediction unit 260 and the intra-prediction unit 265 of the decoding apparatus equally or in a corresponding manner.

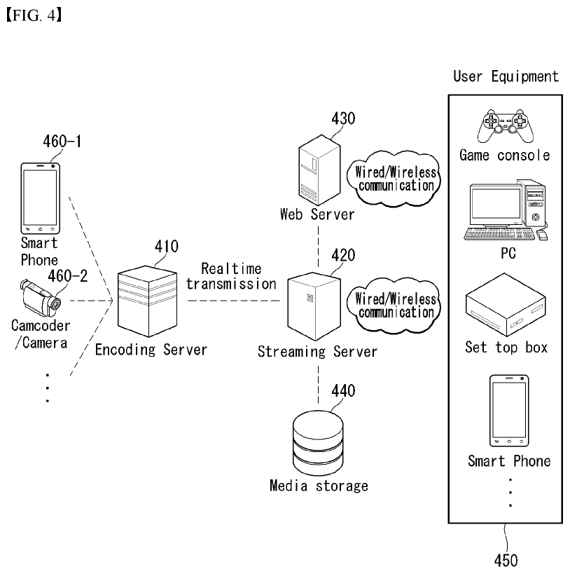

FIG. 4 is a configuration diagram of a content streaming system as an embodiment of the present disclosure.

The content streaming system to which the present disclosure is applied may include an encoding server 410, a streaming server 420, a web server 430, a media storage 440, a user equipment 450, and multimedia input devices 460.

The encoding server 410 serves to compress content input from multimedia input devices such as a smartphone, a camera and a camcorder into digital data to generate a bitstream and transmit the bitstream to the streaming server 420. As another example, when the multimedia input devices 460 such as a smartphone, a camera and a camcorder directly generate bitstreams, the encoding server 410 may be omitted.

The bitstream may be generated by an encoding method or a bitstream generation method to which the present disclosure is applied and the streaming server 420 can temporarily store the bitstream in the process of transmitting or receiving the bitstream.

The streaming server 420 transmits multimedia data to the user equipment 450 on the basis of a user request through the web server 430 and the web server 430 serves as a medium that informs a user of services. When the user sends a request for a desired service to the web server 430, the web server 430 delivers the request to the streaming server 420 and the streaming server 420 transmits multimedia data to the user. Here, the content streaming system may include an additional control server, and in this case, the control server serves to control commands/responses between devices in the content streaming system.

The streaming server 420 may receive content from the media storage 440 and/or the encoding server 410. For example, when content is received from the encoding server 410, the streaming server 420 can receive the content in real time. In this case, the streaming server 420 may store bitstreams for a predetermined time in order to provide a smooth streaming service.

Examples of the user equipment 450 may include a cellular phone, a smartphone, a laptop computer, a digital broadcast terminal, a PDA (personal digital assistant), a PMP (portable multimedia player), a navigation device, a slate PC, a tablet PC, an ultrabook, a wearable device (e.g., a smartwatch, a smart glass and an HMD (head mounted display)), a digital TV, a desktop computer, a digital signage, etc.

Each server in the content streaming system may be operated as a distributed server, and in this case, data received by each server can be processed in a distributed manner.

Block Partitioning

The video/image coding method according to this document may be performed based on various detailed technologies, and each of the detailed technologies will be outlined as follows. It is obvious to the skilled in the art that the technologies described below may relate to related procedures such as prediction, residual processing (transformation, quantization, etc.), syntax element coding, filtering, partitioning/segmentation in the video/image encoding/decoding procedure described above and/or below.

Partitioning Structure

Partitioning of Picture into CTUs

Pictures may be divided into a sequence of coding tree units (CTUs). The CTU may correspond to a coding tree block (CTB). Alternatively, the CTU may include a coding tree block of luma samples and two coding tree blocks of corresponding chroma samples. In other words, for a picture including three sample arrays, the CTU may include an N×N block of luma samples and two corresponding blocks of chroma samples.

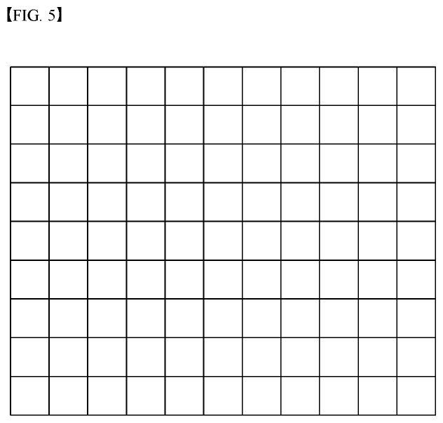

FIG. 5 shows an example of a picture divided into CTUs.

A maximum allowed size of the CTU for coding and prediction may be different from a maximum allowed size of the CTU for transformation. For example, a maximum allowable size of a luma block in the CTU may be 128×128 (even if the maximum size of the luma CTUs is 64×64).

Partitioning of CTU Using Tree Structure

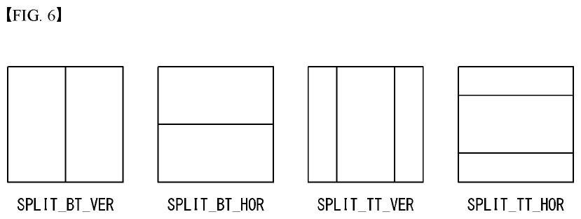

FIG. 6 illustrates an example of multi-type tree splitting modes according to an embodiment of the present disclosure.

The CTU may be split into CUs based on a quadtree (QT) structure. The quadtree structure may be referred to as a quaternary tree structure. This is to reflect various local characteristics. In the present disclosure, the CTU may be split based on multi-type tree structure splitting including binary tree (BT) and ternary tree (TT) in addition to quadtree. Hereinafter, a QTBT structure may include quadtree and binary-tree based splitting structures and QTBTTT may include quadtree, binary-tree, and ternary-tree based splitting structures. Alternatively, the QTBT structure may include the quadtree, binary-tree, and ternary-tree based partitioning structures. In the coding tree structure, the CU may have a square or rectangular shape. The CTU may be first split into the quadtree structure. Thereafter, leaf nodes of the quadtree structure may be additionally split by a multi-type tree structure. For example, as shown in FIG. 6, the multi-type tree structure may include four partition types schematically.

The four partition types shown in FIG. 6 may include vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). Leaf nodes of the multi-type tree structure may be called CUs. These CUs may be used for prediction and transformation procedures. In this document, in general, CU, PU, and TU may have the same block size. However, when a maximum supported transform length is smaller than a width or height of a color component of the CU, the CU and the TU may have different block sizes.

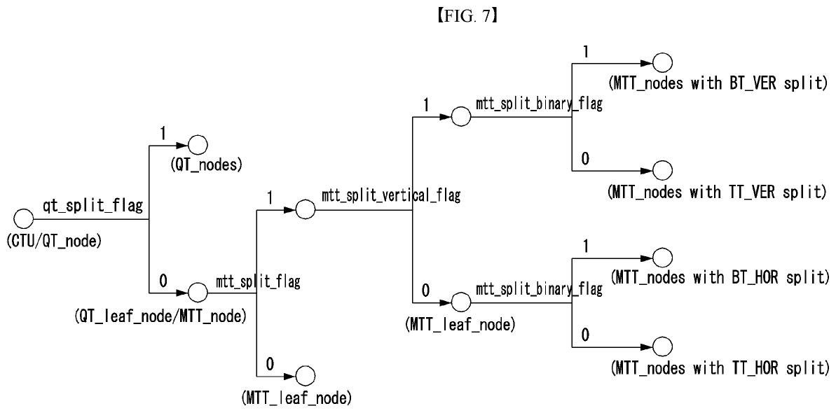

FIG. 7 shows an example of a signaling mechanism for partitioning information in a quadtree with nested multi-type tree structure.

Here, the CTU is treated as a root of the quadtree and first partitioned into the quadtree structure. Thereafter, each quadtree leaf node may be further partitioned into the multi-type tree structure. In the multi-type tree structure, a first flag (e.g., mtt_split_cu_flag) is signaled to indicate whether a corresponding node is additionally partitioned. When the corresponding node is additionally partitioned, a second flag (e.g., mtt_split_cu_verticla_flag) may be signaled to indicate a splitting direction. Thereafter, a third flag (e.g., mtt_split_cu_binary_flag) may be signaled to indicate whether a splitting type is binary splitting or ternary splitting. For example, based on the mtt_split_cu_vertical_flag and the mtt_split_cu_binary_flag, a multi-type tree splitting mode MttSplitMode of the CU may be derived as shown in Table 1 below.

TABLE 1

| | mtt_split_cu_{—} | mtt_split_cu_{—} |
|---|---|---|
| MttSplitMode | vertical_flag | binary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

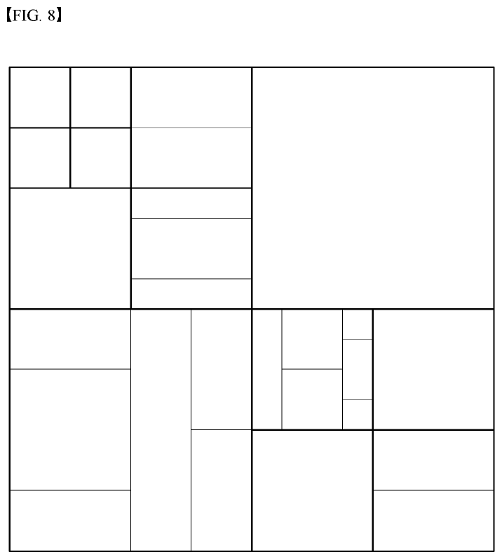

FIG. 8 exemplarily shows that a CTU is partitioned into multiple CUs based on a quadtree and nested multi-type tree structure.

Here, bold block edges indicate quadtree partitioning and the remaining edges indicate multi-type tree partitioning. The quadtree partitioning accompanying the multi-type tree may provide a content-adapted coding tree structure. The CU may correspond to a coding block (CB). Alternatively, the CU may include a coding block of the luma samples and two coding blocks of the corresponding chroma samples. The size of the CU may be as large as the CTU or may be as small as 4×4 in units of the luma sample. For example, in the case of a 4:2:0 color format (or chroma format), a maximum chroma CB size may be 64×64 and a minimum chroma CB size may be 2×2.

In the present disclosure, for example, a maximum supported luma TB size may be 64×64 and a maximum supported chroma TB size may be 32×32. When the width or height of the CB split according to the tree structure is larger than a maximum transform width or height, the corresponding CB may be automatically (or implicitly) split until horizontal and vertical TB size limitations are satisfied.

For a quadtree coding tree scheme accompanying the multi-type tree, the following parameters may be defined and identified as an SPS (sequence parameter set) syntax element.
CTU size: The root node size of a quaternary tree
MinQTSize: The minimum allowed quaternary tree leaf node size
MaxBtSize: The maximum allowed binary tree root node size
MaxTtSize: The maximum allowed ternary tree root node size)
MaxMttDepth: The maximum allowed hierarchy depth of multi-type tree splitting from a quadtree leaf
MinBtSize: The minimum allowed binary tree leaf node size
MinTtSize: The minimum allowed ternary tree leaf node size

As an example of a quadtree coding tree structure with a multitype tree, the CTU size may be set to 128×128 luma samples and 64×64 blocks of two corresponding chroma samples (in 4:2:0 chroma format). In this case, MinOTSize is set to 16×16, MaxBtSize may be set to 128×128, MaxTtSzie may be set to 64×64, MinBtSize and MinTtSize (for width and height) may be set to 4×4, and MaxMttDepth may be set to 4. Quadtree partitioning may be applied to the CTU to create quadtree leaf nodes. The quadtree leaf node may be referred to as a leaf QT node. Quadtree leaf nodes may have a size of 128×128 (i.e., CTU size) from 16×16 (i.e., MinOTSize). If the leaf QT node is 128×128, it may not be additionally partitioned into a binary tree/ternary tree. This is because, in this case, even if the leaf QT node is partitioned, it exceeds MaxBtsize and MaxTtszie (that is, 64×64). In other cases, the leaf QT node may be further partitioned into a multi-type tree. Therefore, the leaf QT node is a root node for a multi-type tree, and the leaf QT node may have a multi-type tree depth (mttDepth) of 0. If the multi-type tree depth reaches MaxMttdepth (e.g., 4), additional partitioning may not be considered any more. If a width of the multi-type tree node is equal to MinBtSize and smaller than or equal to 2×MinTtSize, additional horizontal partitioning may not be considered. If a height of the multi-type tree node is equal to MinBtSize and smaller than or equal to 2×MinTtSize, additional vertical partitioning may not be considered any more.

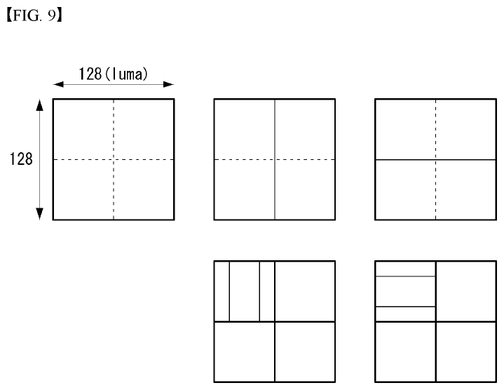

In order to allow 64×64 luma block and 32×32 chroma pipeline design in a hardware decoder, TT partitioning may be forbidden in certain cases. For example, when the width or height of the luma coding block is greater than 64, TT partitioning may be prohibited as shown in FIG. 9. Also, for example, when the width or height of the chroma coding block is greater than 32, TT partitioning may be prohibited.

FIG. 9 shows an example in which TT partitioning is restricted for a 128×128 coding block.

In the present disclosure, a coding tree scheme may support that luma and chroma blocks have a separate block tree structure. For P and B slices, luma and chroma CTBs in a single CTU may be limited to have the same coding tree structure. However, for I slices, luma and chroma blocks may have a separate block tree structure. If a separate block tree mode is applied, a luma CTB may be split into CUs based on a specific coding tree structure, and a chroma CTB may be split into chroma CUs based on a different coding tree structure. This may mean that a CU in the I slice may consist of a coding block of luma component or coding blocks of two chroma components, and a CU in the P or B slice may consist of blocks of three color components.

In the “Partitioning of CTUs using a tree structure” described above, the quadtree coding tree structure with nested multi-type tree has been described, but a structure in which a CU is partitioned is not limited thereto. For example, BT structure and TT structure may be interpreted as the concept included in a multiple partitioning tree (MPT) structure, and it may be interpreted that a CU is partitioned through QT structure and MPT structure. In an example where a CU is partitioned through the QT structure and the MPT structure, a syntax element (e.g., MPT_split_type) including information on how many blocks a leaf node of the QT structure is split, and a syntax element (e.g., MPT_split_mode) including information on whether a leaf node of the QT structure is split in a vertical direction or a horizontal direction may be signaled, and thus a partitioning structure may be determined.

In another example, a CU may be partitioned in a different method from QT structure, BT structure or TT structure. That is, unlike that a CU of deeper depth is partitioned to ¼ size of a CU of upper depth according to the QT structure, or a CU of deeper depth is partitioned to ½ size of a CU of upper depth according to the BT structure, or a CU of deeper depth is partitioned to ¼ size or ½ size of a CU of upper depth according to the TT structure, a CU of deeper depth may be partitioned to ⅕, ⅓, ⅜, ⅗, ⅔ or ⅝ size of a CU of upper depth if necessary or desired, but a method of partitioning a CU is not limited thereto.

Partitioning of CTUs Using Tree Structure

If a portion of the tree node block exceeds the bottom or right picture boundary, the corresponding tree node block may be restricted such that all samples of all coded CUs are positioned within the picture boundaries. In this case, for example, the partitioning rule shown in Table 2 below may be applied.

```
TABLE 2
If a portion of a tree node block exceeds both the bottom and the right picture boundaries,
  If the block is a QT node and the size of the block is larger than the minimum QT size, the
block is forced to be split with QT split mode.
  Otherwise, the block is forced to be split with SPLIT_BT_HOR mode
Otherwise if a portion of a tree node block exceeds the bottom picture boundaries,
  If the block is a QT node, and the size of the block is larger than the minimum QT size, and the
size of the block is larger than the maximum BT size, the block is forced to be split with QT split mode.
  Otherwise, if the block is a QT node, and the size of the block is larger than the minimum QT
size and the size of the block is smaller than or equal to the maximum BT size, the block is forced to be
split with QT split mode or SPLIT_BT_HOR mode.
  Otherwise (the block is a BTT node or the size of the block is smaller than or equal to the
minimum QT size), the block is forced to be split with SPLIT_BT_HOR mode.
Otherwise if a portion of a tree node block exceeds the right picture boundaries,
  If the block is a QT node, and the size of the block is larger than the minimum QT size, and the
size of the block is larger than the maximum BT size, the block is forced to be split with QT split mode.
  Otherwise, if the block is a QT node, and the size of the block is larger than the minimum QT
size and the size of the block is smaller than or equal to the maximum BT size, the block is forced to be
split with QT split mode or SPLIT_BT_VER mode.
  Otherwise (the block is a BTT node or the size of the block is smaller than or equal to the
minimum QT size), the block is forced to be split with SPLIT_BT_VER mode.
```

Restrictions on Redundant CU Splits

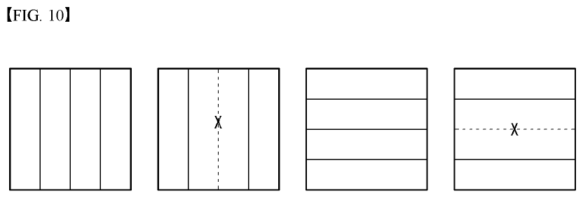

FIG. 10 exemplarily shows redundant partitioning patterns that may occur in binary tree partitioning and ternary tree partitioning.

A quadtree coding block structure with a multitype tree may provide a very flexible block partitioning structure. Because of the partitioning types supported for the multitype tree, different partitioning patterns may potentially lead to the same coding block structure result in some cases. By limiting the occurrence of such redundant partitioning patterns, the amount of data of partitioning information may be reduced.

As shown in FIG. 10, two levels of consecutive binary splits in one direction have the same coding block structure as binary partitioning for center partition after ternary partitioning. In this case, the binary tree partitioning (in the given direction) for the center partition of the ternary tree partitioning is prohibited. This prohibition may be applied to CUs of all pictures. When such specific partitioning is prohibited, signaling of corresponding syntax elements may be modified to reflect such a prohibited case, and through this, the number of bits signaled for partitioning may be reduced. For example, as in the example shown in FIG. 10, when binary tree partitioning for the center partition of the CU is prohibited, the mtt_split_cu_binary_flag syntax element indicating whether the partitioning is binary partitioning or ternary partitioning is not signaled, and the value may be inferred by the decoder as zero.

Inter Prediction

Hereinafter, an inter prediction technique according to an embodiment of the present disclosure will be described. Inter prediction described below may be performed by an inter predictor 180 of an encoding apparatus 100 of FIG. 2 or an inter predictor 260 of a decoding apparatus 200 of FIG. 3.

The predictor of the encoding apparatus 100/decoding apparatus 200 may derive a prediction sample by performing inter prediction on block units. Inter prediction can be a prediction derived in a manner that is dependent on data elements (e.g., sample values or motion information) of picture(s) other than the current picture. When inter prediction is applied to the current block, a predicted block (prediction sample array) for the current block may be derived based on a reference block (reference sample array) specified by a motion vector on a reference picture indicated by a reference picture index. In this case, in order to reduce an amount of motion information transmitted in an inter prediction mode, motion information of the current block may be predicted on a per block, subblock, or sample basis based on a correlation of motion information between the neighboring block and the current block. The motion information may include a motion vector and a reference picture index.

The motion information may further include inter-prediction type (L0 prediction, L1 prediction, Bi prediction, etc.) information. If the inter prediction is applied, a neighboring block may include a spatial neighboring block which is present in the current picture, and a temporal neighboring block which is present in the reference picture. A reference picture including the reference block and a reference picture including the temporal neighboring block may be the same as or different from each other. The temporal neighboring block may be referred to as a name such as a collocated reference block, a collocated CU (colCU), etc., and the reference picture including the temporal neighboring block may be referred to as a collocated picture (colPic). For example, a motion information candidate list may be constructed based on the neighboring blocks of the current block, and a flag or index information indicating which candidate is selected (used) may be signaled in order to derive the motion vector and/or reference picture index of the current block. The inter prediction may be performed based on various prediction modes. For example, in a skip mode and a merge mode, motion information of the current block may be the same as motion information of a selected neighboring block. In the skip mode, a residual signal may not be transmitted unlike the merge mode. In a motion vector prediction (MVP) mode, a motion vector of the selected neighboring block may be used as a motion vector predictor, and a motion vector difference value may be signaled. In this case, a motion vector of the current block may be derived using a sum of the motion vector predictor and the motion vector difference.

A video/image encoding procedure based on inter prediction and the inter predictor 180 in the encoding apparatus 100 may schematically include, for example, the following.

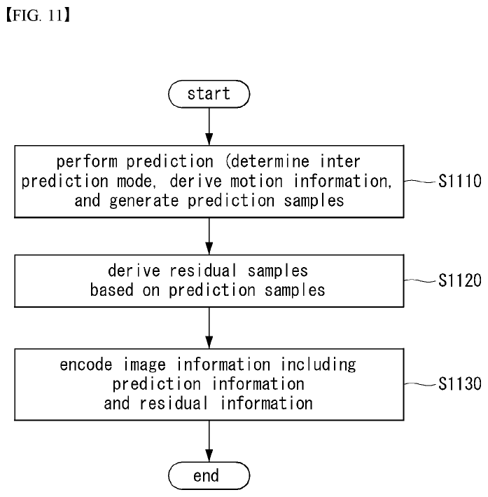

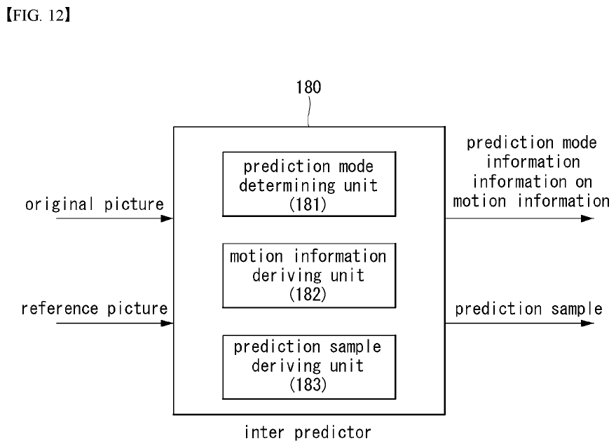

FIGS. 11 and 12 illustrate a video/image encoding procedure based on inter prediction and an inter predictor 180 in the encoding apparatus 100.

The encoding apparatus 100 performs inter prediction on the current block (S1110). The encoding apparatus 100 may derive the inter prediction mode and motion information of the current block and generate prediction samples of the current block. Here, the procedure of determining the inter prediction mode, deriving motion information, and generating prediction samples may be performed simultaneously, or one procedure may be performed before another procedure. For example, the inter predictor 180 of the encoding apparatus 100 may include a prediction mode determining unit 181, a motion information deriving unit 182, and a prediction sample deriving unit 183. The prediction mode determining unit 181 may determine a prediction mode for the current block, the motion information driving unit 182 may derive motion information of the current block, and the prediction sample driving unit 183 may derive prediction samples of the current block. For example, the inter-prediction unit 180 of the encoder 100 may search a block similar to the current block in a predetermined area (search area) of reference pictures through motion estimation, and derive a reference block in which a difference from the current block is minimum or is equal to or less than a predetermined criterion. Based on this, a reference picture index indicating a reference picture at which the reference block is positioned may be derived, and a motion vector may be derived based on a difference in location between the reference block and the current block. The encoder 100 may determine a mode applied to the current block among various prediction modes. The encoder 100 may compare rate-distortion (RD) cost for the various prediction modes and determine an optimal prediction mode for the current block.

For example, when the skip mode or merge mode is applied to the current block, the encoding apparatus 100 may configure a merge candidate list to be described later and derive the current reference block a reference block which is different from the current block by a minimum or certain reference or less among reference blocks indicated by the merge candidates included in the merge candidate list. In this case, a merge candidate related to the derived reference block may be selected, and merge index information indicating the selected merge candidate may be generated and signaled to the decoding apparatus 200. Motion information of the current block may be derived using motion information of the selected merge candidate.

As another example, when the (A) MVP mode is applied to the current block, the encoding apparatus 100 may configure an (A) MVP candidate list to be described later and use a motion vector of a motion vector predictor (MVP) candidate selected from among MVP candidates included in the (A) MVP candidate list as an MVP of the current block. In this case, for example, a motion vector indicating a reference block derived by motion estimation described above may be used as a motion vector of the current block, and an MVP candidate having a motion vector whose difference from the motion vector of the current block, among the MVP candidates, is the smallest may be the selected MVP candidate. A motion vector difference (MVD), which is a difference obtained by subtracting the MVP from the motion vector of the current block, may be derived. In this case, information on MVD may be signaled to the decoding apparatus 200. In addition, when the (A) MVP mode is applied, the value of the reference picture index may be configured as reference picture index information and separately signaled to the decoding apparatus 200.

The encoding apparatus 100 may derive residual samples based on the prediction samples (S1120). The encoding apparatus 100 may derive residual samples by comparing original samples of the current block and prediction samples.

The encoding apparatus 100 encodes video information including prediction information and residual information (S1130). The encoding apparatus 100 may output the encoded image information in the form of a bitstream. The prediction information may be information related to a prediction procedure and may include prediction mode information (e.g., skip flag, merge flag, or mode index) and motion information. The motion information may include candidate selection information (e.g., merge index, mvp flag, or mvp index) that is information for deriving a motion vector. Further, the motion information may include information on the aforementioned MVD and/or reference picture index information. In addition, the motion information may include information indicating whether L0 prediction, L1 prediction, or bi prediction is applied. The residual information is information on residual samples. The residual information may include information on quantized transform coefficients for residual samples.

The output bitstream may be stored in a (digital) storage medium and transmitted to a decoding apparatus or may be transmitted to a decoding apparatus through a network.

Meanwhile, as described above, the encoding apparatus may generate a reconstructed picture (including reconstructed samples and a reconstructed block) based on the reference samples and the residual samples. This is for the encoding apparatus 100 to derive the same prediction result as that performed by the decoding apparatus 200, thereby increasing coding efficiency. Accordingly, the encoding apparatus 100 may store a reconstructed picture (or reconstructed samples and reconstructed block) in a memory and use the same as a reference picture for inter prediction. As described above, an in-loop filtering procedure or the like may be further applied to the reconstructed picture.

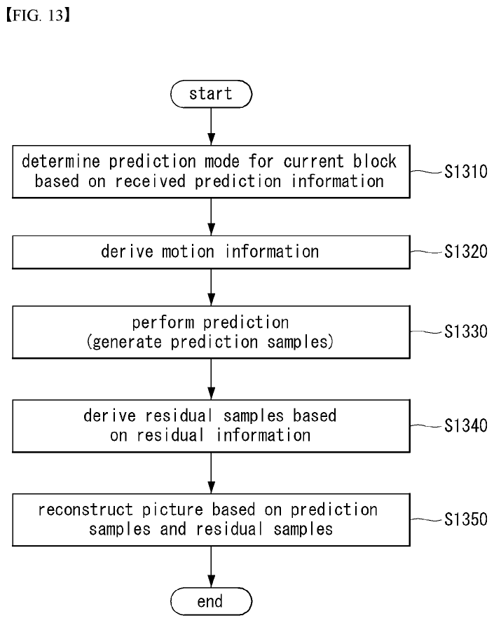

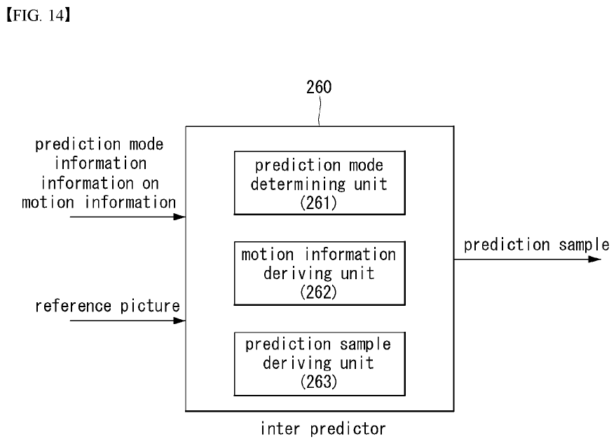

FIGS. 13 and 14 illustrate a video/image decoding procedure based on inter prediction and an inter predictor in a decoding apparatus.

The decoding apparatus 200 may perform an operation corresponding to an operation performed by the encoding apparatus 100. The decoding apparatus 200 may perform prediction on the current block based on the received prediction information and derive prediction samples.

In more detail, the decoding apparatus 200 may determine a prediction mode for the current block based on the received prediction information (S1310). The decoding apparatus 200 may determine which inter prediction mode is applied to the current block based on prediction mode information in the prediction information.

For example, the decoding apparatus 200 may determine whether a merge mode is applied to the current block or the (A) MVP mode is determined based on a merge flag. Alternatively, the decoding apparatus 200 may select one of various inter prediction mode candidates based on a mode index. Inter prediction mode candidates may include a skip mode, a merge mode, and/or (A) MVP mode, or may include various inter prediction modes to be described later.

The decoding apparatus 200 derives motion information of the current block based on the determined inter prediction mode (S1320). For example, when the skip mode or the merge mode is applied to the current block, the decoding apparatus 200 may configure a merge candidate list to be described later, and select one of merge candidates included in the merge candidate list. The selection of a merge candidate may be performed based on a merge index. Motion information of the current block may be derived from motion information of the selected merge candidate. Motion information of the selected merge candidate may be used as motion information of the current block.

As another example, when the (A) MVP mode is applied to the current block, the decoding apparatus 200 configures a (A) MVP candidate list to be described later, and use a motion vector of a selected MVP candidate among MVP candidates included in the (A) MVP candidate list, as an MVP of the current block. The selection of MVP may be performed based on the aforementioned selection information (MVP flag or MVP index). In this case, the decoding apparatus 200 may derive the MVD of the current block based on the information on the MVD, and may derive a motion vector of the current block based on the MVP and the MVD of the current block. Also, the decoding apparatus 200 may derive the reference picture index of the current block based on the reference picture index information. A picture indicated by the reference picture index in the reference picture list for the current block may be derived as a reference picture referred to for inter prediction of the current block.

Meanwhile, as described later, motion information of the current block may be derived without constructing a candidate list, and in this case, motion information of the current block may be derived according to a procedure disclosed in a prediction mode to be described later. In this case, the configuration of the candidate list as described above may be omitted.

The decoding apparatus 200 may generate prediction samples for the current block based on motion information of the current block (S1330). In this case, the decoding apparatus 200 may derive a reference picture based on the reference picture index of the current block and may derive the prediction samples of the current block using samples of the reference block indicated on the reference picture by the motion vector of the current block. In this case, as will be described later, in some cases, a prediction sample filtering procedure may be further performed on all or part of the prediction samples of the current block.

For example, the inter predictor 260 of the decoding apparatus 200 may include a prediction mode determining unit 261, a motion information deriving unit 262, and a prediction sample deriving unit 263. The prediction mode determining unit 181 may determine a prediction mode for the current block based on the received prediction mode information, the motion information deriving unit 182 may derive motion information (a motion vector and/or a reference picture index, etc.) of the current block based on the information on the received motion information, and the prediction sample deriving unit 183 may derive prediction samples of the current block.

The decoding apparatus 200 generates residual samples for the current block based on received residual information (S1340). The decoding apparatus 200 may generate reconstructed samples for the current block based on the prediction samples and the residual samples, and generate a reconstructed picture based thereon. (S1350). Thereafter, as described above, an in-loop filtering procedure or the like may be further applied to the reconstructed picture.

As described above, the inter prediction procedure may include an inter prediction mode determining step, a step of deriving motion information based on a determined prediction mode, and a step of performing prediction (generating prediction sample) based on the derived motion information.

Determination of Inter Prediction Mode

Various inter prediction modes may be used for prediction of a current block in a picture. For example, various modes such as merge mode, skip mode, MVP mode, and affine mode may be used. A DMVR (decoding apparatus side motion vector refinement) mode, an AMVR (adaptive motion vector resolution), or the like may be further used as an auxiliary mode. The affine mode may also be referred to as an affine motion prediction mode. The MVP mode may also be referred to as an advanced motion vector prediction (AMVP) mode.

Prediction mode information indicating the inter prediction mode of the current block may be signaled from the encoding apparatus to the decoding apparatus 200. The prediction mode information may be included in a bitstream and received by the decoding apparatus 200. The prediction mode information may include index information indicating one of a plurality of candidate modes. Alternatively, the inter prediction mode may be indicated through hierarchical signaling of flag information. In this case, the prediction mode information may include one or more flags. For example, the encoding apparatus 100 may signal the skip flag to indicate whether to apply the skip mode and signal the merge flag to indicate whether to apply the merge mode when the skip mode is not applied, and when the merge mode is not applied, the encoding apparatus may indicate whether to apply the MVP mode or may further signal a flag for additional classification. The affine mode may be signaled as an independent mode or may be signaled as a mode dependent on the merge mode or the MVP mode. For example, the affine mode may be configured as a candidate of a merge candidate list or an MVP candidate list, as described later.

Derivation of Motion Information According to Inter Prediction Mode

The encoding apparatus 100 or the decoding apparatus 200 may perform inter prediction using motion information of the current block. The encoding apparatus 100 may derive optimal motion information for the current block through a motion estimation procedure. For example, the encoding apparatus 100 may search for a similar reference block with high correlation using an original block in an original picture for the current block in units of fractional pixels within a predetermined search range in the reference picture, and derive motion information therethrough. Similarity of the block may be derived based on a difference between the phase-based sample values. For example, the similarity of blocks may be calculated based on a sum of absolute difference (SAD) between the current block (or a template of the current block) and the reference block (or a template of the reference block). In this case, motion information may be derived based on the reference block having the smallest SAD in the search area. The derived motion information may be signaled to the decoding apparatus according to various methods based on the inter prediction mode.

Merle Mode and Skip Mode

When the merge mode is applied, motion information of the current prediction block is not directly transmitted, and motion information of the current prediction block is derived using motion information of a neighboring prediction block. Accordingly, the encoding apparatus 100 may indicate motion information of the current prediction block by transmitting flag information indicating that the merge mode has been used and a merge index indicating which prediction block has been used.

In order to perform the merge mode, the encoding apparatus 100 should search for a merge candidate block used to induce motion information of the current prediction block. For example, up to five merge candidate blocks may be used, but the present disclosure is not limited thereto. In addition, the maximum number of merge candidate blocks may be transmitted in a slice header, and the present disclosure is not limited thereto. After finding the merge candidate blocks, the encoding apparatus 100 may generate a merge candidate list and select a merge candidate block having the lowest cost among them as a final merge candidate block.

The present disclosure provides various embodiments of a merge candidate block constituting the merge candidate list.

The merge candidate list may use, for example, five merge candidate blocks. For example, four spatial merge candidates and one temporal merge candidate may be used.

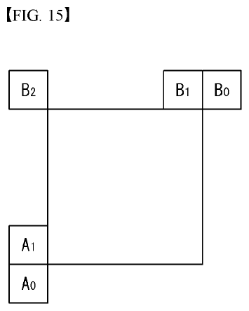

FIG. 15 shows an example of a configuration of a spatial merge candidate for a current block.

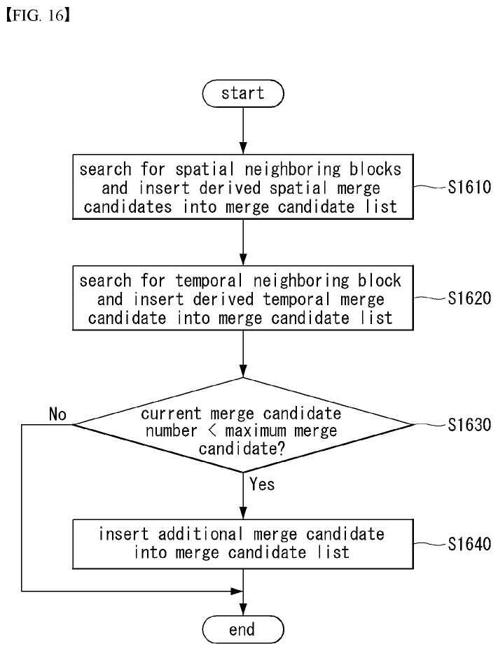

The merge candidate list for the current block may be configured based on A procedure shown in FIG. 16.

FIG. 16 illustrates an example of a flowchart for constructing a merge candidate list according to an embodiment of the present disclosure.

The coding apparatus (encoder/decoder) searches for spatial neighboring blocks of the current block and inserts derived spatial merge candidates into a merge candidate list (S1610). For example, the spatial neighboring blocks may include a lower left corner neighboring block, a left neighboring block, an upper right corner neighboring block, an upper neighboring block, and an upper left corner neighboring block of the current block. However, this is an example and in addition to the spatial neighboring blocks described above, additional neighboring blocks such as a right neighboring block, a lower neighboring block, and a lower right neighboring block may be further used as the spatial neighboring blocks. The coding apparatus may detect available blocks by searching spatial neighboring blocks based on priority and derive motion information of the detected blocks as spatial merge candidates. For example, the encoding apparatus 100 or the decoding apparatus 200 may search for five blocks shown in FIG. 15 in order of A1, B1, B0, A0, and B2, sequentially index available candidates, and configure a merge candidate list.

The coding apparatus searches for temporal neighboring blocks of the current block and inserts a derived temporal merge candidate into the merge candidate list (S1620). The temporal neighboring block may be located on a reference picture that is a picture different from the current picture in which the current block is located. A reference picture in which a temporal neighboring block is located may be referred to as a collocated picture or a col picture. The temporal neighboring block may be searched in the order of a lower-right corner neighboring block and a lower-right center block of a co-located block with respect to the current block on the collocated picture. Meanwhile, when motion data compression is applied, specific motion information may be stored as representative motion information for each predetermined storage unit in the collocated picture. In this case, it is not necessary to store motion information for all blocks in a predetermined storage unit, whereby a motion data compression effect may be obtained. In this case, the predetermined storage unit may be predetermined, for example, in a 16×16 sample unit or an 8×8 sample unit, or size information for the predetermined storage unit may be signaled from the encoding apparatus 100 to the decoding apparatus 200. When motion data compression is applied, motion information of a temporal neighboring block may be replaced with representative motion information of a predetermined storage unit in which a temporal neighboring block is located. In other words, in this case, in terms of implementation, a temporal merge candidate may be derived based on motion information of a prediction block that covers a position of arithmetically left shifted after arithmetical right shifting by a predetermined value based on coordinates of a temporal neighboring block (upper left sample position), not a prediction block located at coordinates of a temporal neighboring block. For example, if the predetermined storage unit is 2n×2n sample unit, if coordinates of the temporal neighboring block are (xTnb, yTnb), motion information of a prediction block located at a modified position ((xTnb>>n)<<n), (yTnb>>n)<<n)) may be used for the temporal merge candidate. Specifically, for example, if the predetermined storage unit is a 16×16 sample unit, if the coordinates of the temporal neighboring block are (xTnb, yTnb), motion information of a prediction block located at a modified position ((xTnb>>4)<<4), (yTnb>>4)<<4)) may be used for a temporal merge candidate. Alternatively, if the predetermined storage unit is an 8×8 sample unit, if the coordinates of the temporal neighboring block are (xTnb, yTnb), motion information of the prediction block located at a modified position ((xTnb>>3)<<3), (yTnb>>3)<<3)) may be used for the temporal merge candidate.

The coding apparatus may check whether the number of current merge candidates is smaller than a maximum number of merge candidates (S1630). The maximum number of merge candidates may be defined in advance or may be signaled from the encoding apparatus 100 to the decoding apparatus 200. For example, the encoding apparatus 100 may generate information on the maximum number of merge candidates, encode the information, and transmit the information to the decoding apparatus 200 in the form of a bitstream. When the maximum number of merge candidates is filled, a subsequent candidate addition process may not be performed.

As a result of checking, if the number of current merge candidates is smaller than the maximum number of the merge candidates, the coding apparatus inserts an additional merge candidate into the merge candidate list (S1640). The additional merge candidate may include, for example, adaptive temporal motion vector prediction (ATMVP), combined bi-predictive merge candidate (when a slice type of the current slice is B type), and/or zero vector merge candidate.

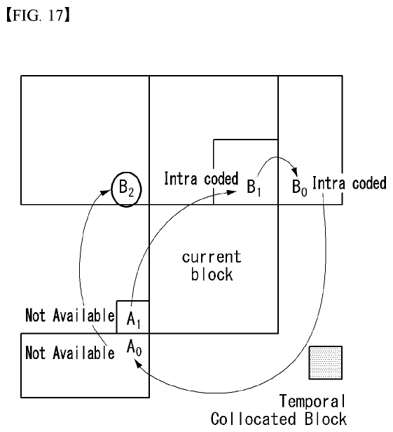

FIG. 17 shows an example of a method for performing ATMVP.

For reference, ATMVP is a method of correcting temporal similarity information in consideration of spatial similarity of neighboring blocks, as shown in FIG. 17. ATMVP may be proposed as a method to improve the existing TMVP method. In other words, TMVP using the motion vector of colPB at the center position of the current block or the right-bottom block of the current block does not reflect intra-screen motion, so a motion vector of colPB at a position indicated by the motion vector of the neighboring block may be used as an MVP. A method of applying ATMVP is shown in FIG. 17.

While checking each block in the order of the merge candidate composition, a motion vector or temporal vector of a spatial neighbor block which can be used first is searched, and then a position indicated by a temporal vector in a reference picture is designated as col-PB. Using this method, prediction accuracy of the current block may be improved.

According to an embodiment, a motion vector of the current block may be derived in units of subblocks using a temporal vector. In this case, if there is no motion vector in a specific subblock, a motion vector of a block located at the center of the current block may be used as a motion vector for an unavailable subblock, and the motion vector may be stored as a representative motion vector.

In order to use the ATMVP mode, the number of merge candidates may be increased, and an additional syntax is not used. In a sequence parameter set (SPS), a maximum number of merge candidates is increased to 6, and a process of checking an existing candidate list of {A1, B1, B0, A0, B2, Combined bi-pred, Zero vector} is changed to {A1, B1, B0, A0, ATMVP, B2, Combined bi-pred, Zero vector}.

As a result of checking the merge candidate list, when the number of current merge candidates is not less than the maximum number of merge candidates, the coding apparatus may terminate the configuration of the merge candidate list. In this case, the encoding apparatus 100 may select an optimal merge candidate among merge candidates constituting the merge candidate list based on a rate-distortion (RD) cost, and selection information indicating the selected merge candidate (e.g., merge index) may be signaled to the decoding apparatus 200. The decoding apparatus 200 may select an optimal merge candidate based on the merge candidate list and selection information.

As described above, the motion information of the selected merge candidate may be used as motion information of the current block, and prediction samples of the current block may be derived based on the motion information of the current block as described above. The encoding apparatus 100 may derive residual samples of the current block based on the prediction samples and may signal residual information on the residual samples to the decoding apparatus 200. As described above, the decoding apparatus 200 may generate reconstructed samples based on residual samples and prediction samples derived based on the residual information, and generate a reconstructed picture based on the residual samples.

When the skip mode is applied, motion information of the current block may be derived in the same manner as when the merge mode is applied. However, when the skip mode is applied, the residual signal for the corresponding block is omitted, and thus prediction samples may be directly used as reconstructed samples.

MVP Mode

When the motion vector prediction (MVP) mode is applied, a motion vector predictor (MVP) candidate list may be generated using a motion vector of a reconstructed spatial neighboring block (e.g., neighboring block in FIG. 15) and/or a motion vector corresponding to a temporal neighboring block (or Col block). That is, the motion vector of the reconstructed spatial neighboring block and/or the motion vector corresponding to the temporal neighboring block may be used as a motion vector predictor candidate. The information on prediction may include selection information (e.g., an MVP flag or an MVP index) indicating an optimal motion vector predictor candidate selected from among the motion vector predictor candidates included in the list. In this case, the predictor may select a motion vector predictor of the current block from among motion vector predictor candidates included in the motion vector candidate list using the selection information. The predictor of the encoding apparatus 100 may obtain a motion vector difference (MVD) between the motion vector of the current block and the motion vector predictor and may encode the MVD and output it in the form of a bitstream. That is, MVD may be obtained by subtracting the motion vector predictor from the motion vector of the current block. In this case, the predictor of the decoding apparatus 200 may obtain the MVD included in the prediction information, and derive the motion vector of the current block through the addition of the MVD and the motion vector predictor. The predictor of the decoding apparatus 200 may obtain or derive a reference picture index indicating a reference picture from information on prediction. For example, a configuration of the MVP candidate list may be performed as shown in FIG. 17.

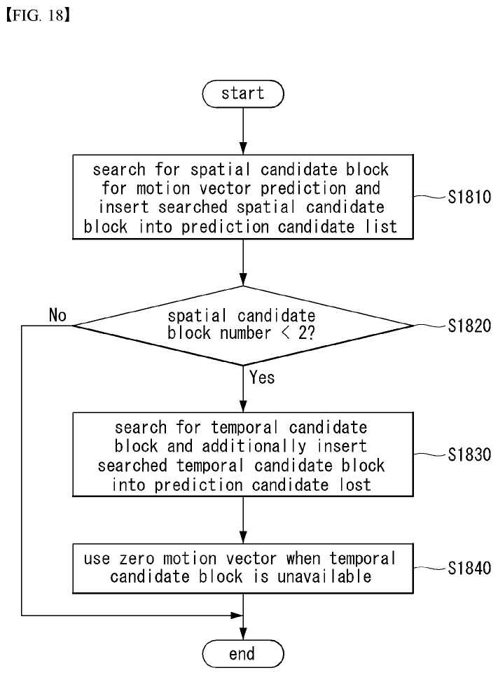

FIG. 18 shows an example of a flowchart for constructing a prediction candidate list (MVP candidate list).

Referring to FIG. 18, the coding apparatus searches for a spatial candidate block for motion vector prediction and inserts searched spatial candidate block into a prediction candidate list (S1810). For example, the coding apparatus may search for neighboring blocks according to a predetermined search order, and add information on neighboring blocks that satisfy a condition for the spatial candidate block to the prediction candidate list (MVP candidate list).

After constructing the spatial candidate block list, the coding apparatus compares the number of spatial candidate lists included in the prediction candidate list with a preset reference number (e.g., 2) (S1820). When the number of spatial candidate lists included in the prediction candidate list is greater than or equal to the reference number (e.g., 2), the coding apparatus may terminate constructing of the prediction candidate list.

However, when the number of spatial candidate lists included in the prediction candidate list is less than the reference number (e.g., 2), the coding apparatus searches for a temporal candidate block and additionally inserts a searched temporal candidate block into the prediction candidate list (S1830), and if temporal candidate block is not available, the coding apparatus adds a zero motion vector to the prediction candidate list (S1840).

Generation of Prediction Sample

The coding apparatus may derive a predicted block for the current block based on motion information derived according to the prediction mode. The predicted block may include prediction samples (prediction sample array) of the current block. When the motion vector of the current block indicates a fractional sample unit, an interpolation procedure may be performed, and through this, prediction samples of the current block may be derived based on reference samples of the fractional sample unit in a reference picture. When affine inter prediction is applied to the current block, prediction samples may be generated based on MV in units of samples/subblocks. When bi-prediction (or bidirectional prediction) is applied, final prediction samples may be derived through weighted sum (depending on phase) of prediction samples derived based on L0 prediction and prediction samples derived based on L1 prediction.

Reconstructed samples and reconstructed pictures may be generated based on the derived prediction samples, and then a procedure such as in-loop filtering may be performed as described above.

Hereinafter, a method of constructing an advanced merge candidate according to an embodiment of the present disclosure will be described. Embodiments of the present disclosure relate to a method and apparatus for encoding/decoding a still image or video and to a method for generating a merge candidate in a merge mode or a skip mode during inter prediction, and a merge candidate configuration.

Hereinafter, embodiments of the present disclosure relate to a method of generating a merge candidate and a merge list construction, and an object thereof is to improve coding efficiency without increasing coding complexity (pruning process, scaling process).

### Embodiment 1

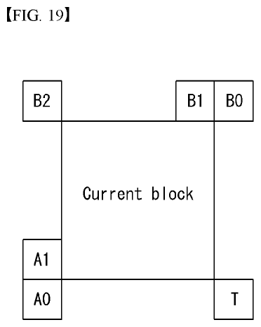

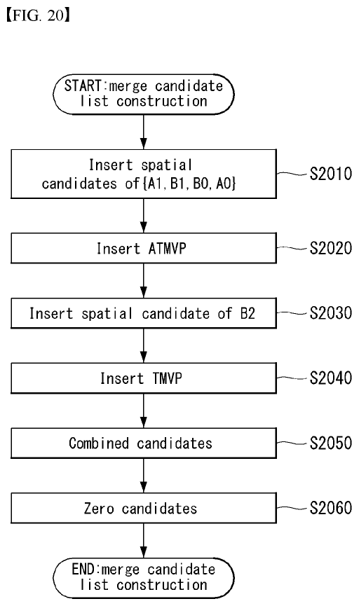

FIGS. 19 and 20 illustrate an example of a method of constructing a merge candidate list.

In this embodiment, a merge mode will be described as a specific embodiment of a merge mode or a skip mode (hereinafter, a merge mode and a skip mode are combined as a merge mode), and a specific merge candidate list construction (or merge list construction) is performed in the following order (see FIGS. 19 and 20).

1) Insert spatial candidate {A1, B1, A0, B0} into merge candidate list

2) Insert ATMVP

3) Insert spatial candidate {B2}

4) Insert TMVP candidate {T}

5) Insert combined candidate

6) Insert zero candidate

Here, temporal motion vector predictor (TMVP) refers to a temporal merge candidate.

The scanning order of spatial candidate blocks (spatial motion vector predictors) A1, B1, A0, and B0 may be A1-B1-B0-A0, but embodiments of the present disclosure are not limited thereto, and other scanning orders may be applied. Embodiments 2 to 6 of the present disclosure may be applied for merge candidate list construction and may also be applied to other merge list construction methods.

The encoder/decoder may check whether the same candidate exists in the candidate list by performing a pruning process on spatial candidate blocks A1, B1, A0, B0, and B2. Here, the pruning process may include comparing motion vectors (MV) of two candidate blocks with a reference index. If the same candidate exists in the candidate list, the corresponding candidate is not selected (or determined) as a merge candidate. Meanwhile, in the case of the remaining candidates (ATMVP, TMVP, combined candidate, zero candidate), the pruning process may not be performed.

The encoder/decoder may perform a scaling process for TMVP and/or ATMVP. For example, the encoder/decoder may scale a motion vector (MV) of each candidate of TMVP and/or ATMVP according to a value when the reference index is 0.

As described above, the merge candidate list construction considers various candidates, and to this end, a plurality of pruning processes and/or scaling processes are performed. As shown in Table 3 below, the pruning process and/or the scaling process includes comparison, multiplication, and/or division operation, which is a factor that increases coding complexity. Therefore, when an additional candidate is considered, a method capable of minimizing the scaling process and the pruning process is required.

TABLE 3

| | Comparison | Multiplication | Division |
|---|---|---|---|
| Scaling | 11 | 3 | 1 |
| Pruning | 12 | 0 | 0 |

More specifically, referring to FIG. 20, the coding apparatus may search for and insert spatial candidates {A1, B1, B0, A0} (S2010), search for and insert merge candidates according to ATMVP (S2020), search for and insert spatial candidate {B2}. (S2030), search for and insert a merge candidate according to TMVP (S2040), combined candidate determination and insertion (S2050), determine and insert combined candidate, perform zero candidate insertion (S2060), and terminate construction of the merge candidate list. In generating the merge candidate list of FIG. 20, the scanning order of A1, B1, A0, and B0 may be A1-B1-B0-A0, but the present embodiment is not limited thereto, and other scanning orders may be applied.

### Embodiment 2

The present embodiment relates to a method of generating a merge candidate that may be additionally considered in a merge mode.

Since the present embodiment relates to a method of determining a merge candidate, the encoding apparatus 100 and the decoding apparatus 200 may perform determining in the same manner.

For convenience of explanation, terms are defined as follows.

1) L-predictor: First valid candidate among {A1, A0} candidates

2) A-predictor: First valid candidate among {B1, B0} candidates

3) AL-predictor: a valid B2 candidate

4) T-predictor: a valid TMVP candidate

Here, the meaning of ‘effective’ means a case in which a corresponding candidate is considered as a merge candidate and exists in the merge candidate list. For example, a valid B2 candidate refers to a case in which a B2 candidate exists in the merge candidate list through a merge candidate construction process. If there is no valid candidate, the predictor does not exist.

A scan order for finding the first valid candidate on the L-predictor and A-predictor may be A1-A0, B1-B0 in the same manner as the scan order in the merge list construction, but the present disclosure is not limited thereto does not limit the other scan order (A0-A1 or B1-B0).

In addition to the merge candidates described above, the following merge candidates may be additionally generated to construct a merge candidate list.

1) L/A candidate: When L-predictor and A-predictor exist and the reference frames or reference indexes of the two predictors are the same, the encoder/decoder may generate a merge candidate and define the generated merge candidate as an L/A candidate. In this case, the MV of the L/A candidate may be determined (or set) as an average value of the MVs of the L-predictor and the A-predictor. In addition, the reference index of the L/A candidate may be determined (or set) as the reference index of the L-predictor and the A-predictor.

The L/A candidate may be determined after checking A1, B1 blocks (Case 1) or may be determined after checking A1, B1, B0, A0 blocks (Case 2). In case 1, the L-predictor may be the A1 candidate and the A-predictor may be the B1 candidate. Case 1 is effective when the L/A candidate is a candidate superior to B0 and A0, and Case 2 may be effective when the L/A candidate is a candidate not superior to B0 and A0.

2) AL/L candidate: When an AL-predictor and an L-predictor exist and reference frames or reference indexes of the two predictors are the same, the encoder/decoder may create a merge candidate and define a generated merge candidate as an AL/L candidate. In this case, the MV of the AL/L candidate may be determined (or set) as an average value of the MVs of the AL-predictor and the L-predictor. In addition, a reference index of the AL/L candidate may be determined (or set) as a reference index of the AL-predictor and the L-predictor.

3) AL/A candidate: When an AL-predictor and an A-predictor exist and reference frames or reference indexes of the two predictors are the same, the encoder/decoder may generate a merge candidate and define the generated merge candidate as an AL/A candidate. In this case, an MV of the AL/A candidate may be determined (or set) as an average value of the MVs of the AL-predictor and A-predictor. In addition, the reference index of the AL/A candidate may be determined (or set) as a reference index of the AL-predictor and A-predictor.

4) T/AL candidate: When a T-predictor and an AL-predictor exist and reference frames or reference indexes of the two predictors are the same, the encoder/decoder may generate a merge candidate define the generated merge candidate as a T/AL candidate. In this case, an MV of the T/AL candidate may be determined (or set) as an average value of the MVs of the T-predictor and the AL-predictor. In addition, the reference index of the T/AL candidate may be determined (or set) as a reference index of the T-predictor and the AL-predictor.

5) T/L candidate: When a T-predictor and an L-predictor exist and reference frames or reference indexes of the two predictors are the same, the encoder/decoder may generate a merge candidate and define the generated merge candidate as a T/L candidate. In this case, an MV of the T/L candidate may be determined (or set) as an average value of the MVs of the T-predictor and the L-predictor. In addition, the reference index of the T/L candidate may be determined (or set) as a reference index of the T-predictor and the L-predictor.

6) T/A candidate: When a T-predictor and an A-predictor exist and reference frames or reference indexes of the two predictors are the same, the encoder/decoder may generate a merge candidate and define the generated merge candidate as a T/A candidate. In this case, an MV of the T/A candidate may be determined (or set) as an average value of the MVs of the T-predictor and the A-predictor. In addition, the reference index of the T/A candidate may be determined (or set) as a reference index of the T-predictor and the A-predictor.

6) L/A/AL/T candidate: When an L-predictor, a A-predictor, an AL-predictor, and a T-predictor exist and reference frames or reference indexes of the L-predictor, A-predictor, the AL-predictor, and the T-predictor are the same, merge candidates in which an average value of MVs of the L-predictor, the A-predictor, the AL-predictor, and the T-predictor are MV and reference indexes of the L-predictor, the A-predictor, the AL-predictor, and the T-predictor are reference indexes are generated and defined as L/A/AL/T candidates.

As described above, generating a candidate based on the average value is intuitively valid from the viewpoint of motion continuity. For example, if the movement of block A1 and block B1 are determined, movement of the current block is highly likely to be movement of block A1, movement of block B1, movement having an average value of block A1 and block B1, or movement between block A1 and block B1. Therefore, this movement may be expressed using the L/A candidate.

It is reasonable for the reference frame to consider only the same predictor in that a scaling process may be avoided. Since the scaling process already includes division and multiplication operations as mentioned in Table 3, computational complexity is very high. Considering an average candidate for a case where reference frames are different may not be desirable in terms of complexity because a process of scaling to a specific reference frame is required.

A pruning process for candidates generated by the method proposed in this embodiment is not performed. This has little deterioration due to not performing a pruning check in terms of probability because it has at least two candidates different from the at least two candidates included in the merge candidate list as the average value is determined using predictors that have already been identified as different candidates. For example, L/A candidate may be determined when L-predictor and A-predictor are already included in the candidate list. When L-predictor and A-predictor are included in the candidate list, it means that the two predictors have different values. Therefore, since the L/A candidates generated by the two predictors have different values from those of the two predictors, the pruning process does not need to be performed.

A merge candidate that may be additionally generated may be used together with an existing merge candidate list constructing method or another merge candidate list constructing method.

In the process of additionally generating merge candidates (L/A candidate or L/A/AL/T candidate), MV may be generated by applying a predefined weight, instead of obtaining it by averaging the MVs of the two predictors.

In addition, a total of 7 candidates may be considered in the merge candidate list in whole or only in part.

### Embodiment 3

The present embodiment relates to a method of constructing a merge candidate list.

The present embodiment specifically relates to a method of constructing a merge candidate list using the candidate proposed in the second embodiment.

This embodiment may be performed in the same manner in the encoder and the decoder.

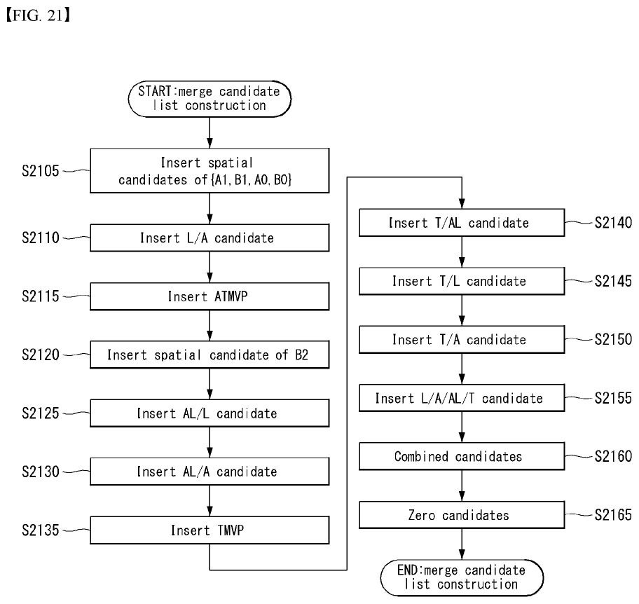

FIG. 21 illustrates another example of a method of constructing a merge candidate list according to an embodiment of the present disclosure.

In consideration of the candidate proposed in the second embodiment, a merge candidate list may be constructed as shown in FIG. 21. When constructing a merge candidate list, the order between the AL/L candidate and the AL/A candidate may be AL/L candidate-AL/A candidate or AL/A candidate-AL/L candidate. In addition, the order between T/AL candidate, T/L candidate, and T/A candidate may be T/AL candidate-T/L candidate-T/A candidate, T/A candidate-T/L candidate-T/AL candidate, or T/L candidate-T/A candidate-T/AL candidate, and the like. This may be equally applied to all the embodiments (Embodiments 3 to 6) described below.

1) Insert spatial candidate {A1, B1, B0, A0} into the merge candidate list (S2105)

2) Insert L/A candidate (S2110)

3) Insert ATMVP (S2115)

4) Insert spatial candidate {B2} (S2120)

5) Insert AL/L candidate (S2125)

6) Insert AL/A candidate (S2130)

7) Insert TMVP candidate {T} (S2135)

8) Insert T/AL candidate (S2140)

9) Insert T/L candidate (S2145)

10) Insert T/A candidate (S2150)

11) Insert L/A/AL/T candidate (S2155)

12) Insert combined candidate (S2160)

13) Insert zero candidate (S2165)

In the generating of the merge candidate list of FIG. 21, a scanning order of A1, B1, A0, and B0 may be A1-B1-B0-A0, but embodiments of the present disclosure are not limited thereto, and other scanning orders may be applied.

### Embodiment 4

The present embodiment relates to a method of constructing a merge candidate list according to the first embodiment.

The present embodiment specifically relates to a method of constructing a merge candidate list using the candidate proposed in the second embodiment.

In this embodiment, the encoder and the decoder may operate in the same way.

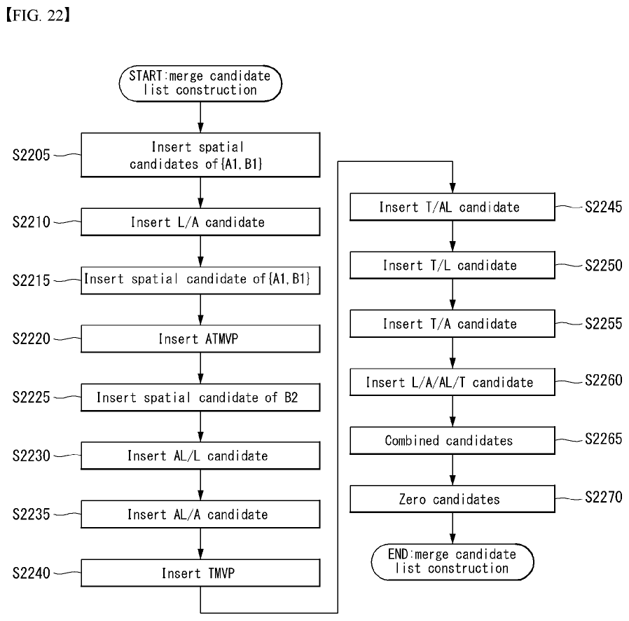

FIG. 22 illustrates another example of a method of constructing a merge candidate list according to an embodiment of the present disclosure.

Considering the candidates proposed in the second embodiment, the merge candidate list construction may be performed in the following order (refer to FIG. 22). This is because the A1 and B1 candidates are relatively important compared to other candidates, so that the L-predictor and the A-predictor for only the L/A candidate are determined by the A1 and B1 candidates, respectively, so that coding performance may be improved.

The order of constructing a merge candidate list according to the present embodiment is as follows.

1) Insert spatial candidate {A1, B1} (S2205)

2) Insert L/A candidate (S2210)

3) Insert spatial candidate {B0, A0} (S2215)

4) Insert ATMVP (S2220)

5) Insert spatial candidate {B2} (S2225)

6) Insert AL/L candidate (S2230)

7) Insert AL/A candidate (S2235)

8) Insert TMVP candidate {T} (S2240)

9) Insert T/AL candidate (S2245)

10) Insert T/L candidate (S2250)

11) Insert T/A candidate (S2255)

12) Insert L/A/AL/T candidates (S2260)

13) Insert combined candidate (S2265)

14) Insert zero candidate (S2270)

### Embodiment 5

The present embodiment relates to a method of constructing a merge candidate list according to the first embodiment.

The present embodiment specifically relates to a method of constructing a merge candidate list using the candidate proposed in the second embodiment.

The present embodiment specifically relates to a method of constructing a merge candidate list by selecting and/or using some of the candidates proposed in the second embodiment.

This embodiment may operate in the same way in the encoder and the decoder.

A probability that, among the candidates proposed in Example 2, the AL/L candidate, the AL/A candidate, the T/AL candidate, and the L/A/AL/T candidate generated using the AL-predictor are selected as optimal merge candidates is very low. This is because a probability that the B2 candidate used as the AL-predictor is considered as a candidate of the current block is very low. Accordingly, the merge candidate list may be constructed as follows in consideration of excellent candidates.

1) Insert spatial candidate {A1, B1, B0, A0} into merge candidate list

2) Insert L/A candidates

3) Insert ATMVP

4) Insert spatial candidate {B2}

5) Insert TMVP candidate {T}

6) Insert T/L candidate

7) Insert T/A candidate

8) Insert combined candidate

9) Insert zero candidate

Alternatively, a merge candidate list construction may be performed as follows.

1) Insert spatial candidate {A1, B1} into merge candidate list

2) Insert L/A candidates

3) Insert spatial candidate {B0, A0} into merge candidate list

4) Insert ATMVP candidates

5) Insert spatial candidate {B2}

6) Insert TMVP candidate {T}

7) Insert T/L candidates

8) Insert T/A candidate

9) Insert combined candidate

10) Insert zero candidate

### Embodiment 6

In the method of adding merge candidates proposed in Embodiment 3, Embodiment 4, and Embodiment 5, only some candidates, instead of all candidates, may be added. As described below, when only candidates having effective performance is considered, computational complexity for generating candidates may be reduced, and since effective candidates may be considered preferentially in a list, encoding efficiency may be advantageously increased.

For example, when only a combination of an L-predictor and an A-predictor, which has a relatively large influence on encoding efficiency, is considered, the merge candidate list construction may be performed as follows.

1) Insert spatial candidate {A1, B1, B0, A0} into merge candidate list

2) Insert L/A candidate

3) Insert ATMVP candidate

4) Insert spatial candidate {B2}

5) Insert TMVP candidate {T}

6) Insert combined candidate

7) Insert zero candidate

Alternatively, a merge candidate list construction may be performed as follows.

1) Insert spatial candidate {A1, B1} into merge candidate list

2) Insert L/A candidate

3) Insert spatial candidate {B0, A0} into merge candidate list

4) Insert ATMVP candidate

5) Insert spatial candidate {B2}

6) Insert TMVP candidate {T}

7) Insert combined candidate

8) Insert zero candidate

In addition, when only a combination of the L-predictor or the A-predictor and the T-predictor is considered as a merge candidate to be added, the merge candidate list construction may be performed as follows. In this case, since the T-predictor is also an effective predictor similar to the L-predictor or the A-predictor, coding efficiency may be sufficiently increased even if only the corresponding combination is considered. This is because the T/L candidate and the T/A candidate may be used after TMVP, so that a small number of candidates before TMVP may be advantageous in considering the corresponding candidate. For reference, as described in Embodiment 2, the T/L candidate and the T/A candidate may be changed in order and applied.

1) Insert spatial candidate {A1, B1, B0, A0} into merge candidate list

2) Insert ATMVP candidate

3) Insert spatial candidate {B2}

4) Insert TMVP candidate {T}

5) Insert T/L candidate

6) Insert T/A candidate

7) Insert combined candidate

8) Insert zero candidate

### Embodiment 7

The present embodiment relates to a method of generating a merge candidate that may be considered in the merge mode of embodiment 1, and provides a method of generating an additional candidate (average candidate) from an average value of candidates that already exist in the merge candidate list. The average candidate may be considered after the determination/insertion of the TMVP candidate and before the determination/search of the combined candidate.

The average candidate may be considered when candidates present in the candidate list have the same reference index or reference frame. When a reference index of a first candidate in a current candidate list is a target reference index and there is a candidate having the same reference index as the target reference index, a merge candidate having an average value of MVs of the corresponding two candidates as an MV and having reference indexes of the two candidates as a reference index may be generated and defined as an average candidate.

In this embodiment, the encoder/decoder may configure an average candidate using merge candidates having the same reference index (or reference frame) among merge candidates existing in the merge candidate list.

Specifically, when a reference index of the first candidate in the current candidate list is a target reference index, the MV of the average candidate may be determined (or induced or calculated) as an average value of MVs of the candidate and the first candidate having the same reference index as the target reference index. In addition, the reference index of the average candidate may be determined as a reference index of the first candidate.

In other words, the encoder/decoder has ma generate an average candidate having the MV as an average value of the MVs of the first candidate of the candidate list and the candidate having the same reference index as the first candidate and having the same reference index as reference indexes of the two candidates.

As an embodiment, assuming that there are a maximum of 4 candidates in the merge candidate list after TMVP insertion (or addition), a maximum of 3 average candidates may be considered. Specifically, if an average candidate using a first candidate and a q-th candidate among the candidates present in the candidate list is expressed as lq-candidate, candidates such as Equation 1 below may be considered as average candidates. For example, the encoder/decoder may insert (or add) valid (or available) candidates to the merge candidate list as average candidates in the order of Equation 1. In this case, whether the candidate is valid may be determined according to whether the reference indexes of the two candidates are the same. However, the embodiment of the present disclosure is not limited to the order of Equation 1 and two merge candidates in the merge candidate list used for generating an average candidate may be considered (or selected) in various orders.

{12-candidate,13-candidate,14-candidate,23-candidate,24-candidate,34-candidate} [Equation 1]

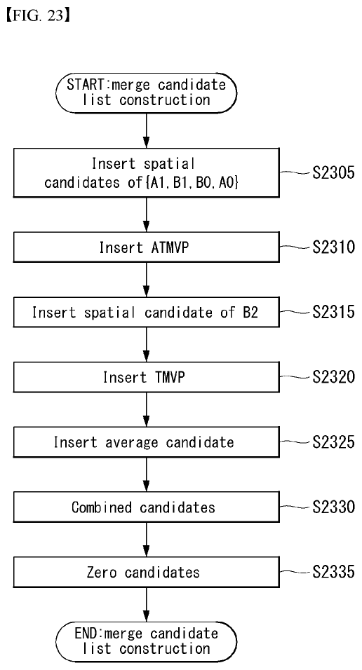

FIG. 23 illustrates another example of a method of constructing a merge candidate list according to an embodiment of the present disclosure.

More specifically, as shown in FIG. 23, an average candidate may be determined in the merge candidate list construction.

1) Insert spatial candidate {A1, B1, A0, B0} into the merge candidate list (S2305)

2) Insert ATMVP (S2310)

3) Insert the spatial candidate {B2} (S2315)

4) Insert TMVP candidate {T} (S2320)

5) Insert average candidate {12-candidate, 13-candidate, 14-candidate, 23-candidate, 24-candidate, 34-candidate} (S2325)

6) Insert combined candidate (S2330)

7) Insert zero candidate (S2335)

In FIG. 23, after the TMVP candidate insertion step (S2310), the encoder/decoder may generate an average candidate using merge candidates having the same reference index among merge candidates existing in the merge candidate list and insert the generated average candidate into the merge candidate list.

As an embodiment, an average candidate insertion step (S2325) of FIG. 23 may include checking merge candidates having the same reference index among merge candidates existing in the merge candidate list. In addition, the average candidate insertion step (S2325) of FIG. 23 may include checking whether the reference indexes between two merge candidates are the same in a predetermined order (e.g., in the order of Equation 1).

### Embodiment 8

The present embodiment relates to a method of generating a merge candidate that may be additionally considered in a merge mode of the second embodiment, and specifically provides a method of generating an average candidate of candidates already in the merge candidate list. The average candidate may be considered after the determination/insertion of the TMVP candidate and before the determination/insertion of the combined candidate.

The average candidate may be considered when a candidate existing in the candidate list has the same reference index or reference frame. Specifically, when there is a candidate having the same reference index as the reference index of the first candidate in the current candidate list, a merge candidate having an average value of MVs of the corresponding two candidates as an MV and having reference indexes of the two candidates as a reference index and defined as an average candidate.

In this embodiment, the encoder/decoder may generate an average candidate using merge candidates having the same reference index (or reference frame) among merge candidates existing in the merge candidate list.

Specifically, when the reference index of the first candidate in the current candidate list is a target reference index, MV of the average candidate MV may be determined (or induced or calculated) as an average value of MVs of the candidate having the same reference index as the target reference index and the first candidate. In addition, the reference index of the average candidate may be determined as the reference index of the first candidate.

In other words, the encoder/decoder may generate an average candidate having an average value of MVs of the first candidate of the candidate list and the candidate having the same reference index as the first candidate as an MV and having the same reference index as the reference indexes of the two candidates.

As an embodiment, assuming that there are a maximum of 4 candidates in the merge candidate list after TMVP insertion (or addition), a maximum of 3 average candidates may be considered. Specifically, if an average candidate using a first candidate and a q-th candidate among the candidates present in the candidate list is expressed as lq-candidate, candidates such as Equation 2 below may be considered as average candidates. For example, the encoder/decoder may insert (or add) valid (or available) candidates to the merge candidate list as average candidates in the order of Equation 1. In this case, whether the candidate is valid may be determined according to whether the reference indexes of the two candidates are the same.

However, the embodiment of the present disclosure is not limited to the order of Equation 2 and two merge candidates in the merge candidate list used for generating an average candidate may be considered (or selected) in various orders.

{12-candidate,13-candidate,14-candidate} [Equation 2]

Specifically, an average candidate may be determined in the merge candidate construction as follows.

1) Insert spatial candidates {A1, B1, A0, B0} into merge candidate list (S2305)

2) Insert ATMVP candidate (S2310)

3) Insert spatial candidate {B2} (S2315)

4) Insert TMVP candidate {T} (S2320)

5) Insert average candidate {12-candidate, 13-candidate, 14-candidate} (S2325)

6) Insert combined candidate (S2330)

7) Insert zero candidate (S2335)

### Embodiment 9

Encoded information (e.g., encoded video/image information) derived by the encoding apparatus 100 based on the aforementioned embodiments (Embodiments 2 to 8) may be output in the form of a bitstream. The encoded information may be transmitted or stored in a bitstream form in units of network abstraction layers (NALs). The bitstream may be transmitted over a network or may be stored in a non-transitory digital storage medium. In addition, as described above, the bitstream may not be directly transmitted from the encoding apparatus 100 to the decoding apparatus 200 but may be streamed or downloaded through an external server (e.g., a content streaming server). Here, the network may include a broadcast network and/or a communication network, and the digital storage medium may include various storage mediums such as USB, SD, CD, DVD, Blu-ray, HDD, and SSD.

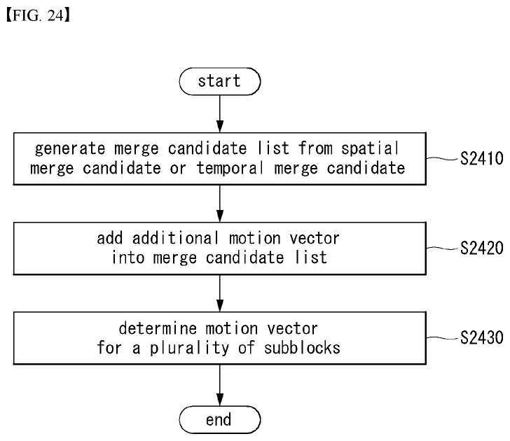

FIG. 24 shows an example of a flowchart for performing prediction according to an embodiment of the present disclosure. Each of the processes of FIG. 24 may be performed by the inter predictor 180 of the encoding apparatus 100 or the inter predictor 260 of the decoding apparatus 200.

In step S2410, the coding apparatus generates a merge candidate list including a plurality of motion vectors derived from a spatial merge candidate or a temporal merge candidate of the current block. For example, the merge candidate list may be performed by searching for a motion vector for a temporal merge candidate after searching for a motion vector for a spatial merge candidate. In addition, the motion vector search for the spatial candidate may be performed in the order of the left block (A0), the upper block (B1), the upper right block (B0), the lower left block (A0), and the upper left block in FIG. 19.

In step S2420, when the number of merge candidates in the merge candidate list is smaller than a maximum number of merge candidates, the coding apparatus adds an additional motion vector determined as an average value of the motion vectors to the merge candidate list.

In an embodiment, the coding apparatus adds an average value of a first motion vector corresponding to a first index (index #0) and a second motion vector corresponding to a second index (index #1) in the merge candidate list, as an additional motion vector.

In an embodiment, when the number of merge candidates in the merge candidate list to which the additional motion vector is added is less than the maximum number of merge candidates, the coding apparatus may add a zero motion vector to the merge candidate list.

In an embodiment, when motion vectors refer to the same reference picture, an additional motion vector may be determined as an average value of existing motion vectors. In addition, an additional motion vector may be set to refer to a reference picture that is equally referred to by existing motion vectors.

In step S2430, the coding apparatus generates a prediction sample of the current block using a motion vector indicated by a merge index in the merge candidate list.

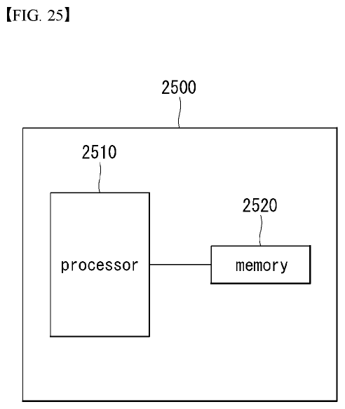

FIG. 25 illustrates an example of a block diagram of an apparatus for processing an image signal according to an embodiment of the present disclosure. The image signal processing apparatus of FIG. 25 may correspond to the encoding apparatus 100 of FIG. 2 or the decoding apparatus 200 of FIG. 3.

An image processing apparatus 2500 for processing an image signal includes a memory 2520 for storing an image signal and a processor 2510 coupled to the memory and processing an image signal.

The processor 2510 according to an embodiment of the present disclosure may be configured with at least one processing circuit for processing an image signal, and may process the image signal by executing instructions for encoding or decoding the image signal. That is, the processor 2510 may encode original image data or decode an encoded image signal by executing the aforementioned encoding or decoding methods.

The embodiments described herein may be implemented and performed on a processor, microprocessor, controller, or chip. For example, functional units shown in each drawing may be implemented and executed on a computer, a processor, a microprocessor, a controller, or a chip.

The processing method to which the present disclosure is applied may be produced in the form of a program executed by a computer, and may be stored in a computer-readable recording medium. Multimedia data having a data structure according to the present disclosure may also be stored in a computer-readable recording medium. The computer-readable recording medium includes all kinds of storage devices and distributed storage devices in which computer-readable data is stored. The computer-readable recording medium may include, for example, Blu-ray disk (BD), universal serial bus (USB), ROM, PROM, EPROM, EEPROM, RAM, CD-ROM, magnetic tape, floppy disk, and optical data storage device. In addition, the computer-readable recording medium includes media implemented in the form of a carrier wave (e.g., transmission through the Internet). In addition, a bitstream generated by the encoding method may be stored in a computer-readable recording medium or transmitted through a wired or wireless communication network.

In addition, the embodiments of the present disclosure may be implemented as a computer program product using a program code, and the program code may be executed in a computer according to the embodiments of the present disclosure. The program code may be stored on a computer-readable carrier.

The decoding apparatus and the encoding apparatus to which the present disclosure is applied may be included in a digital device. The term “digital device” includes, for example, all digital devices capable of transmitting, receiving, processing, and outputting data, content, and services. Here, processing of data, content, service, etc. by the digital device includes an operation of encoding and/or decoding data, content, service, and the like. These digital devices transmit and receive data by pairing or connecting with other digital devices, external servers, etc. (hereinafter, “paired”) through a wired/wireless network, and perform converting as necessary.

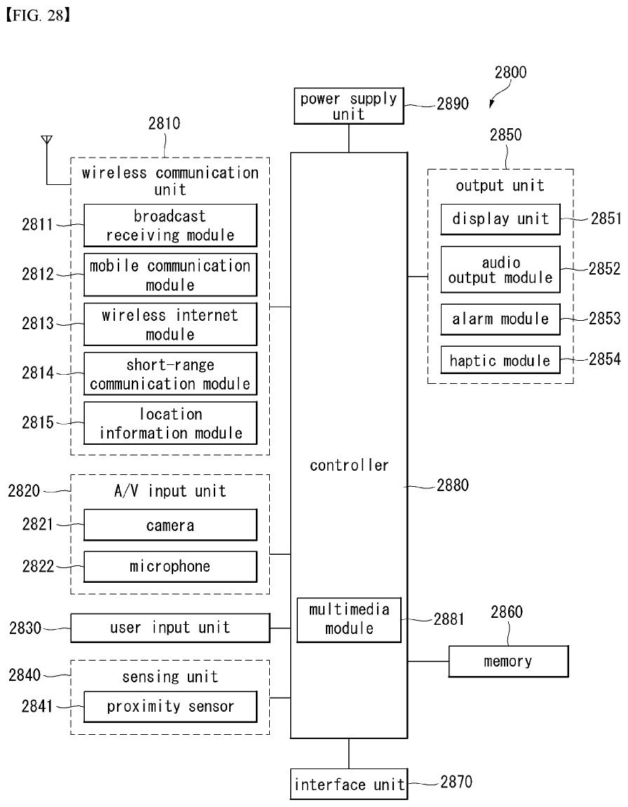

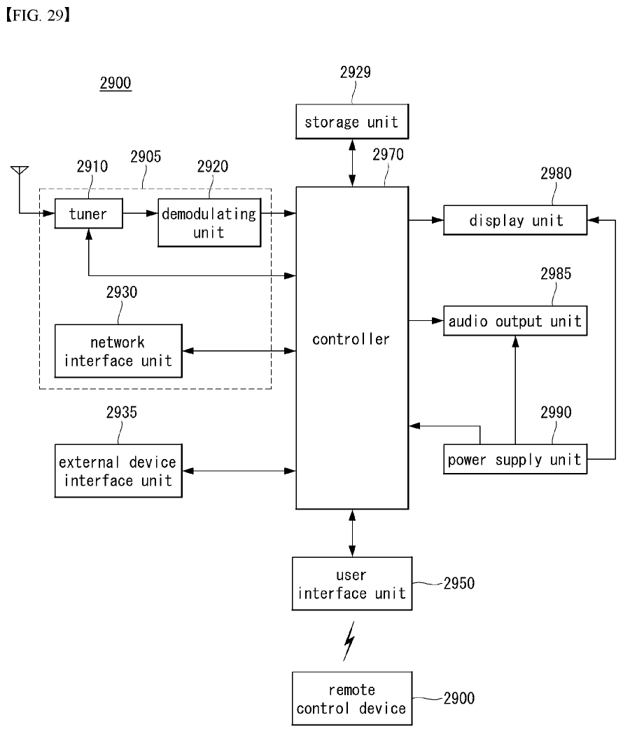

Digital devices include, for example, all of standing devices such as network TV, hybrid broadcast broadband TV (HBBTV), smart TV, Internet protocol television (IPTV), personal computer (PC) and mobile devices or handheld devices such as a mobile device or handheld device such as a personal digital assistant (PDA), a smart phone, a tablet PC, and a notebook. In this disclosure, for convenience, a digital TV is illustrated and described as an example of a digital device in FIG. 29 and a mobile device is illustrated and described as an example of a digital device in FIG. 28.

Meanwhile, the term “wired/wireless network” described herein collectively refers to a communication network supporting various communication standards or protocols for interconnection or/and data transmission/reception between digital devices or between digital devices and an external server. Such a wired/wireless network may include both a communication network to be supported presently or in the future by the standard and may be formed by a communication standard or protocol for wired connection such as universal serial bus (USB), composite video banking sync (CVBS), component, S-video (analog), digital visual interface (DVI), high definition multimedia interface (HDMI), RGB, or D-SUB and a communication standard for wireless communication such as Bluetooth, radio frequency identification (RFID), infrared data association (IrDA), ultra wideband (UWB), ZigBee, digital living network alliance (DLNA), wireless LAN (WLAN), wireless broadband (Wibro), world interoperability for microwave access (Wimax), high speed downlink packet access (HSDPA), long term evolution (LTE), Wi-Fi direct.

Hereinafter, when simply referred to, the digital device may refer to a standing device or a mobile device or both according to context.

Meanwhile, a digital device is an intelligent device that supports, for example, a broadcast reception function, a computer function or support, and at least one external input, and may support an e-mail through the wired/wireless network, Web browsing, banking, games, applications, etc. In addition, the digital device may include an interface for supporting at least one input or control means (hereinafter, input means) such as a handwriting type input device, a touch screen, and a spatial remote control. The digital device may use a standardized general-purpose operating system (OS). For example, digital devices may add, delete, amending, and update various applications on a general-purpose OS kernel, thereby configuring and providing a user-friendly environment.

Meanwhile, an external input described in the present disclosure includes all input means or digital devices that are connected to an external input device, that is, the aforementioned digital device, by wire/wireless connection, and transmit/receive related data therethrough. Here, the external input includes, for example, all of high definition multimedia interface (HDMI), a game device such as a play station or an X-Box, and digital devices such as a smartphone, a tablet PC, a printer, or a smart TV.

In addition, the term “server” described in the present disclosure includes all digital devices or systems that supply data to a client, that is, the aforementioned digital device, and may be referred to as a processor. Such servers may include, for example, a portal server that provides web pages or web content, an advertising server that provides advertising data, a content server that provides content, and a social network service (SNS) server providing an SNS service, a service server or a manufacturing server provided by a manufacturer, and the like.

In addition, the term “channel” described in the present disclosure may refer to a path, means, etc. for transmitting and receiving data, and may be a broadcast channel, for example. Here, the broadcast channel is expressed in terms such as a physical channel, a virtual channel, and a logical channel according to activation of digital broadcasting. The broadcast channel may be called a broadcast network. In this way, a broadcast channel refers to a channel for providing broadcast content provided by a broadcasting station or for accessing from a receiver, and the broadcast content may be referred to as a live channel because it is based on real-time broadcasting. However, in recent years, mediums for broadcasting has become more diversified, non-real time broadcasting in addition to real-time broadcasting is also active, so live channels may be understood as meaning the entire broadcast channels including non-real-time broadcasting in some cases, as well as real-time broadcasting.

In this disclosure, an “arbitrary channel” is further defined in relation to a channel other than the aforementioned broadcast channel. The arbitrary channel may be provided with a service guide such as an electronic program guide (EPG) along with a broadcast channel, or a service guide, a graphic user interface (GUI), or an on-screen display (OSD) may be configured/provided with only an arbitrary channel.

Meanwhile, unlike a broadcast channel having a pre-arranged channel number between transceivers, a random channel is a channel randomly assigned by a receiver, and a channel number that does not basically overlap with a channel number for expressing a broadcast channel is assigned. For example, when a receiver tunes a specific broadcast channel, the receiver receives a broadcast signal for transmitting broadcast content and signaling information for the broadcast content through the tuned channel. Here, the receiver parses channel information from the signaling information, configures a channel browser, EPG, etc. based on the parsed channel information, and provides the same to a user. When the user makes a channel change request through an input means, the receiver responds thereto.

As described above, since the broadcast channel is a content previously agreed between the transmitting and receiving end, if an arbitrary channel is repeatedly allocated with a broadcast channel, confusion may occur or confusion may exist for the user, and thus, overlapping allocation is not performed as described above. Meanwhile, even if a random channel number is not repeatedly allocated with a broadcast channel number as described above, there is still a concern of confusion in the user's channel surfing process. Accordingly, it is required to allocate a random channel number in consideration of this. This is because the arbitrary channel according to the present disclosure may also be implemented to be accessed like a broadcast channel by responding in the same manner according to a user's channel switching request through an input means, similarly to a conventional broadcast channel. Therefore, the arbitrary channel number may be defined and displayed in a form in which characters are added together, such as random channel-1, random channel-2, etc., rather than a number type like a broadcast channel, for convenience of user accessing a random channel and distinguishing or identifying a broadcast channel number. Meanwhile, in this case, although the arbitrary channel number is in the form of a letter such as arbitrary channel-1, it may be recognized and implemented in a numeric form like the number of the broadcast channel inside the receiver. In addition, the arbitrary channel number may be provided in numeric form like a broadcast channel, and channel numbers may be defined and displayed in various ways that may be distinguished from broadcast channels such as video channel-1, title-1, and video-1.

A digital device provides various types of web pages to a user by executing a web browser for a web service. Here, the web page also includes a web page including a video content. In this disclosure, video is separately or independently separated from a web page and processed. In addition, the separated video may be allocated an arbitrary channel number and provided through a service guide or the like and may be implemented to be output according to a channel change request by a user in the process of viewing a service guide or a broadcast channel. In addition to web services, for services such as broadcast content, games, and applications, predetermined content, images, audio, items, etc. may be independently processed separately from the broadcast content, game, and application itself, and for playback, processing, etc. thereof, an arbitrary channel number may be assigned and implemented as described above.

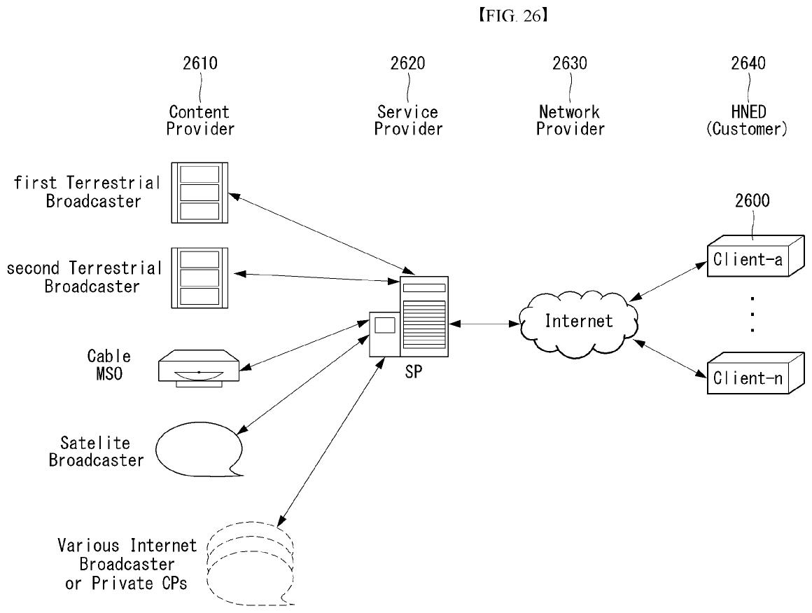

FIG. 26 is a diagram schematically showing an example of a service system including a digital device.

A service system including a digital device includes a content provider (CP) 2610, a service provider (SP) 2620, a network provider (NP) 2630, and a home network end user (HNED) (customer) (2640). Here, the HNED 2640 is, for example, a client 2600, that is, a digital device. The content provider 2610 produces and provides various types of content. As shown in FIG. 26, the content provider 2610 may be, for example, a terrestrial broadcaster, a cable system operator (SO) or multiple SO (MSO), a satellite broadcaster, various Internet broadcasters, private CPs, and the like. Meanwhile, the content provider 2610 provides various applications in addition to broadcast content.

The service provider 2620 provides a service package of content provided by the content provider 2610 to the HNED 2640. For example, the service provider 2620 of FIG. 26 packages a first terrestrial broadcast, a second terrestrial broadcast, a cable MSO, a satellite broadcast, various Internet broadcasts, and applications, and provides the same to the HNED 2640.

The service provider 2620 provides a service to the client 2600 in a uni-cast or multi-cast manner. Meanwhile, the service provider 2620 may transmit data to a plurality of pre-registered clients 2600 at one time, and to this end, an Internet group management protocol (IGMP) may be used.

The content provider 2610 and the service provider 2620 described above may be the same entity (same or single entity). For example, the content produced by the content provider 2610 may be packaged as a service and provided to the HNED 2640 to perform the function of the service provider 2620 or vice versa.

The network provider 2630 provides a network for data exchange between the content provider 2610 or/and the service provider 2620 and the client 2600.

The client 2600 may transmit and receive data by establishing a home network.

Meanwhile, the content provider 2610 or/and the service provider 2620 in the service system may use conditional access or content protection means to protect transmitted content. In this case, the client 2600 may use a processing means such as a cable card (point of deployment, POD) or downloadable CAS (DCAS) in response to the conditional reception or content protection.

In addition, the client 2600 may also use a two-way service through a network (or communication network). In this case, the client 2600 may rather perform the function of a content provider, and the existing service provider 2620 may receive the same and transmit it to another client.

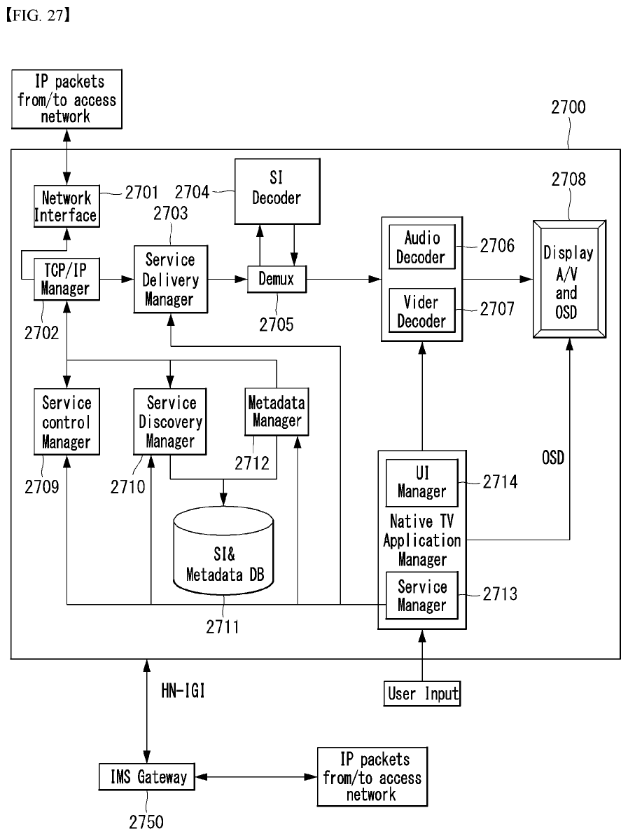

FIG. 27 is a block diagram illustrating a configuration of a digital device according to an embodiment. Here, FIG. 27 may correspond to, for example, the client 2600 of FIG. 26 and refers to the aforementioned digital device.

The digital device 2700 includes a network interface 2701, a TCP/IP manager 2702, a service delivery manager 2703, an SI decoder 2704, a demultiplexer 2705, an audio decoder 2706, an image decoder 2707, a display A/V and OSD module 2708, a service control manager 2709, a service discovery manager 2710, an SI & metadata DB 2711, a metadata manager 2712, a service manager 2613, a UI manager 2714, and the like.

The network interface unit 2701 receives or transmits Internet protocol (IP) packets through a network. That is, the network interface unit 2701 receives services, content, and the like from the service provider 2620 through a network.

The TCP/IP manager 2702 involves packet transfer between a source and a destination for IP packets received by the digital device 2700 and IP packets transmitted by the digital device 2700. In addition, the TCP/IP manager 2702 classifies the received packet(s) to correspond to an appropriate protocol, and outputs the classified packet(s) to the service delivery manager 2705, the service discovery manager 2710, the service control manager 2709, and the metadata manager 2712, etc. The service delivery manager 2703 is responsible for controlling received service data. For example, the service delivery manager 2703 may use RTP/RTCP when controlling real-time streaming data. When real-time streaming data is transmitted using RTP, the service delivery manager 2703 parses the received data packet according to the RTP and transmits it to the demultiplexer 2705 or stores the data packet in the SI & metadata DB 2711 under the control of the service manager 2613. Also, the service delivery manager 2703 feeds back the network reception information to the server providing the service using RTCP. The demultiplexer 2705 demultiplexes the received packet into audio, video, and system information (SI) data, and transmits the same to the audio/image decoder 2706/2707 and the SI decoder 2704, respectively.

The SI decoder 2704 decodes service information such as, for example, program specific information (PSI), program and system information protocol (PSIP), and digital video broadcasting-service information (DVB-SI).

In addition, the SI decoder 2704 stores the decoded service information, for example, in the SI & metadata database 2711. The service information stored in this way may be read and used by a corresponding component according to a user request, for example.

The audio/image decoder 2706/2707 decodes each audio data and video data demultiplexed by the demultiplexer 2705. The decoded audio data and video data are provided to the user through the display unit 2708.

The application manager may include, for example, a UI manager 2714 and a service manager 2713. The application manager may manage an overall state of the digital device 2700, provide a user interface, and manage other managers.

The UI manager 2714 provides a graphic user interface (GUI) for a user using an on-screen display (OSD), etc. and receives a key input from the user and performs a device operation according to the input. For example, when the UI manager 2714 receives a key input for channel selection from the user, the UI manager 2714 transmits a key input signal to the service manager 2713.

The service manager 2713 controls managers related to a service, such as a service delivery manager 2703, a service discovery manager 2710, a service control manager 2709, and a metadata manager 2712.

In addition, the service manager 2713 creates a channel map and selects a channel using the channel map according to a key input received from the user interface manager 2714. In addition, the service manager 2713 receives channel service information from the SI decoder 2704 and sets an audio/video packet identifier (PID) of a selected channel to the demultiplexer 2705. The set PID is used in the demultiplexing process described above. Accordingly, the demultiplexer 2705 filters audio data, video data, and SI data using the PID.

The service discovery manager 2710 provides information necessary to select a service provider that provides a service. Upon receiving a signal regarding channel selection from the service manager 2713, the service discovery manager 2710 searches for a service using the information.

The service control manager 2709 is responsible for service selection and control. For example, the service control manager 2709 may select and control a service using IGMP or RTSP when the user selects a live broadcasting service such as an existing broadcasting method, and using the RTSP when the user selects a service such as video on demand (VOD).

The RTSP protocol may provide a trick mode for real-time streaming. In addition, the service control manager 2709 may initialize and manage a session through the IMS gateway 2750 using an IP multimedia subsystem (IMS) and a session initiation protocol (SIP). The protocols are an example, and other protocols may be used according to implementation examples.

The metadata manager 2712 manages metadata related to a service and stores the metadata in the SI & metadata database 2711.

The SI & metadata database 2711 stores service information decoded by the SI decoder 2704, metadata managed by the metadata manager 2712, and information required for selecting a service provider provided by the service discovery manger 2710. In addition, the SI & metadata database 2711 may store set-up data for the system, and the like.

The SI & metadata database 2711 may be implemented using non-volatile memory (NVRAM) or flash memory.

Meanwhile, the IMS gateway 2750 is a gateway that collects functions necessary for accessing an IMS-based IPTV service.

FIG. 28 is a block diagram illustrating a configuration of a digital device according to another embodiment. In particular, FIG. 28 is a block diagram illustrating a configuration of a mobile device as another embodiment of a digital device.

Referring to FIG. 28, a mobile device 2800 includes a wireless communication unit 2810, an audio/video (A/V) input unit 2820, a user input unit 2830, a sensing unit 2840, and an output unit 2850, a memory 2860, an interface unit 2870, a controller 2880, a power supply unit 2890, and the like. Since the components shown in FIG. 28 are not essential, a mobile device having more components or fewer components may be implemented.

The wireless communication unit 2810 may include one or more modules that enable wireless communication between the mobile device 2800 and the wireless communication system or between the mobile device and a network in which the mobile device is located. For example, the wireless communication unit 2810 may include a broadcast receiving module 2811, a mobile communication module 2812, a wireless Internet module 2813, a short-range communication module 2814, a location information module 2815, and the like.

The broadcast receiving module 2811 receives a broadcast signal and/or broadcast-related information from an external broadcast management server through a broadcast channel. Here, the broadcast channel may include a satellite channel and a terrestrial channel. The broadcast management server may refer to a server that generates and transmits a broadcast signal and/or broadcast-related information or a server that receives and transmits a previously-generated broadcast signal and/or broadcast-related information to a terminal. The broadcast signal may include not only a TV broadcast signal, a radio broadcast signal, and a data broadcast signal, but also a broadcast signal in a form in which a data broadcast signal is combined with a TV broadcast signal or a radio broadcast signal.

The broadcast related information may refer to information related to a broadcast channel, a broadcast program, or a broadcast service provider. The broadcast-related information may also be provided through a mobile communication network. In this case, it may be received by the mobile communication module 2812.

The broadcast-related information may exist in various forms, for example, in the form of an electronic program guide (EPG) or an electronic service guide (ESG).

The broadcast receiving module 2811 may receive a digital broadcast signal using a digital broadcasting system such as, ATSC, DVB-T (digital video broadcasting-terrestrial), DVB-S (satellite), MediaFLO (media forward link only), DVB-H (handheld), ISDB-T (integrated services digital broadcast-terrestrial). Of course, the broadcast receiving module 2811 may be configured to be suitable for not only the digital broadcasting system described above, but also other broadcasting systems.

Broadcast signals and/or broadcast related information received through the broadcast receiving module 2811 may be stored in the memory 2860.

The mobile communication module 2812 transmits and receives a wireless signal with at least one of a base station, an external terminal, and a server on a mobile communication network. The wireless signal may include a voice signal, a video call signal, or various types of data according to transmission and reception of text/multimedia messages.

The wireless Internet module 2813 may be built-in or installed outside the mobile device 2800, including a module for wireless Internet access. Wireless Internet technologies include wireless LAN (WLAN) (Wi-Fi), wireless broadband (Wibro), world interoperability for microwave access (Wimax), high speed downlink packet access (HSDPA), and the like.

The short-range communication module 2814 refers to a module for short-range communication. As short-range communication technology, Bluetooth, radio frequency identification (RFID), infrared data association (IrDA), ultra wideband (UWB), ZigBee, RS-232, RS-485, etc., may be used.

The location information module 2815, as a module for obtaining location information of the mobile device 2800, may be a global positioning system (GPS) module as an example.

The A/V input unit 2820, for inputting audio or/and image signals, may include a camera 2822 and a microphone 2822. The camera 2822 processes image frames such as still images or video obtained by an image sensor in a video call mode or a photographing mode. The processed image frame may be displayed on the display unit 2861.

The image frame processed by the camera 2821 may be stored in the memory 2860 or transmitted to the outside through the wireless communication unit 2810. Two or more cameras 2821 may be provided depending on a use environment.

The microphone 2822 receives an external sound signal by a microphone in a call mode, a recording mode, a voice recognition mode, or the like, and processes it as electrical voice data. In the case of the call mode, the processed voice data may be converted into a form of being transmittable to a mobile communication base station through the mobile communication module 2812 and output. Various noise removal algorithms for removing noise that occurs in a process of receiving an external sound signal may be implemented in the microphone 2822.

The user input unit 2830 generates input data for the user to control the operation of the terminal. The user input unit 2830 may be configured as a key pad, a dome switch, a touch pad (resistive/capacitive), a jog wheel, a jog switch, and the like.

The sensing unit 2840 detects a current status of the mobile device 1800 such as an opening/closing state of the mobile device 2800, a location of the mobile device 2800, the presence or absence of user contact, an orientation of the mobile device, and acceleration/deceleration of the mobile device and generates a sensing signal for controlling the operation of the mobile device 2800. For example, when the mobile device 2800 is moved or tilted, a position or tilting of the mobile device may be sensed. In addition, whether the power supply unit 2890 supplies power or whether the interface unit 2870 is coupled to an external device may also be sensed. Meanwhile, the sensing unit 2840 may include a proximity sensor 2841 including near field communication (NFC).

The output unit 2850 is for generating an output related to visual, auditory or tactile sensation, and the like, and includes a display unit 2851, an audio output module 2852, an alarm unit 2853, a haptic module 2854, and the like.

The display unit 2851 displays (outputs) information processed by the mobile device 2800. For example, when the mobile device is in a call mode, the display nit 2851 displays a user interface (UI) or a graphic user interface (GUI) related to a call. When the mobile device 2800 is in a video call mode or a photographing mode, the display unit 2851 displays a photographed or/and received image, a UI, or a GUI.

The display unit 2861 includes a liquid crystal display (LCD), a thin film transistor-liquid crystal display (TFT LCD), an organic light-emitting diode (OLED), a flexible display, and a 3D display.

Some of these displays may be configured as a transparent type or a light-transmissive type so that the outside may be seen therethrough. This may be referred to as a transparent display, and a typical example of the transparent display is TOLED (transparent OLED). A rear structure of the display unit 2851 may also be configured as a light-transmissive structure. With this structure, the user may see an object located behind the terminal body through an area occupied by the display unit 2851 of the terminal body.

Two or more display units 2851 may exist depending on an implementation type of the mobile device 2800. For example, in the mobile device 2800, a plurality of display units may be spaced apart or integrally disposed on one surface or may be disposed on different surfaces, respectively.

When the display unit 2861 and a sensor (hereinafter referred to as a ‘touch sensor’) for detecting a touch motion form an interlayer structure (hereinafter, referred to as a ‘touch screen’), the display unit 2861 may also be used as an input device in addition to an output device. The touch sensor may have a form of, for example, a touch film, a touch sheet, a touch pad, or the like.

The touch sensor may be configured to convert a change in pressure applied to a specific portion of the display unit 2851 or capacitance occurring in a specific portion of the display unit 2861 into an electrical input signal. The touch sensor may be configured to detect not only a touched position and area but also a pressure at the time of touch.

When a touch input is applied to the touch sensor, a signal(s) corresponding thereto is transmitted to a touch controller. The touch controller processes the signal(s) and then transmits corresponding data to the controller 2880. As a result, the controller 2880 may know which area of the display unit 2851 has been touched or the like.

A proximity sensor 2841 may be disposed in an inner area of the mobile device surrounded by the touch screen or near the touch screen. The proximity sensor refers to a sensor that detects the presence or absence of an object approaching a predetermined detection surface or an object existing in the vicinity using a force of an electromagnetic field or infrared rays without mechanical contact. Proximity sensors have a longer lifespan and higher utilization than contact sensors.

Examples of the proximity sensor include transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared ray proximity sensor, and the like. When a touch screen is of a capacitive type, it is configured to detect proximity of a pointer by a change in an electric field according to the proximity of the pointer. In this case, the touch screen (touch sensor) may be classified as a proximity sensor.

Hereinafter, for convenience of description, an action in which the pointer is not in contact with the touchscreen, but is located close thereto such that the presence of the pointer above the touchscreen is recognized is referred to as “proximity touch”, and an action in which the pointer is actually brought into contact with the touchscreen is referred to as “contact touch”. The position at which the pointer performs “proximity touch” on the touchscreen means the position at which the pointer vertically corresponds to the touchscreen during the proximal touch.

The proximity sensor senses a proximity touch operation and a proximity touch pattern (for example, a proximity touch distance, a proximity touch direction, a proximity touch speed, a proximity touch time, a proximity touch position, and a proximity touch movement state). Information regarding the sensed proximity touch operation and the sensed proximity touch pattern may be output on the touchscreen.

The audio output module 2852 may output audio data which has been received from the wireless communication unit 110 or has been stored in the memory 2860 during a call signal reception mode, a call connection mode, a recording mode, a voice recognition mode, a broadcast reception mode, and the like. The audio output module 2852 may output sound signals related to functions (e.g., call signal reception sound, message reception sound, etc.) carried out in the mobile device 2800. The audio output module 2852 may include a receiver, a speaker, a buzzer, and the like.

The alarm unit 2853 outputs a signal notifying the user that an event has occurred in the mobile device 2800. Examples of the event occurring in the mobile device 2800 include incoming call reception, message reception, key signal input, touch input, etc. The alarm unit 2853 outputs a signal notifying the user of the occurrence of an event in a different form from an audio signal or an image signal. For example, the alarm unit 2853 may output a notification signal through vibration.

The image signal or the audio signal may be output through the display unit 2851 or the audio output module 2852, so that the display unit 2851 and the audio output module 2852 may be classified as parts of the alarm unit 2853.

The haptic module 2854 generates a variety of tactile effects which the user may sense. One typical example of the tactile effects that may be generated by the haptic module 2854 is vibration. In a case where the haptic module 2854 generates vibration as a tactile effect, the haptic module 2854 may change intensity and pattern of generated vibration. For example, the haptic module 2854 may combine different vibrations and output the combined vibration, or may sequentially output different vibrations.

In addition to vibration, the haptic module 2854 may generate various tactile effects, such as a stimulus effect by an arrangement of pins that move perpendicularly to the touched skin surface, a stimulus effect by air blowing or suction through an air outlet or inlet, a stimulus effect through brushing of the skin surface, a stimulus effect through contact with an electrode, a stimulus effect using electrostatic force, and a stimulus effect through reproduction of thermal (cool/warm) sensation using an endothermic or exothermic element.

The haptic module 2854 may be implemented so as to allow the user to perceive such effects not only through direct tactile sensation but also through kinesthetic sensation of fingers, arms, or the like of the user. Two or more haptic modules 154 may be provided depending on how the mobile device 2800 is constructed.

The memory 2860 may store a program for operating the controller 180, and may temporarily store I/O data (for example, a phonebook, a message, a still image, a moving image, etc.). The memory 2860 may store vibration and sound data of various patterns that are output when a user touches the touchscreen.

The memory 2860 may include a storage medium of at least one type of a flash memory, a hard disk, a multimedia card micro type, a card type memory (for example, SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disc, an optical disc, etc. Also, the mobile device 2800 may utilize web storage that performs a storage function of the memory 2860 over the Internet.

The interface unit 2870 may be used as a path via which the mobile device 2800 is connected to all external devices. The interface unit 2870 receives data from the external devices, or receives a power-supply signal from the external devices, such that it transmits the received data and the power-supply signal to each constituent element contained in the mobile device 2800, or transmits data stored in the mobile device 2800 to the external devices. For example, the interface unit 2870 may include a wired/wireless headset port, an external charger port, a wired/wireless data port, a memory card port, a port connected to a device including an identification module, an audio I/O port, a video I/O port, an earphone port, and the like.

An identification module is a chip that stores a variety of information for identifying the authority to use the mobile device 2800, and may include a user identity module (UIM), a subscriber identity module (SIM), a universal scriber identity module (USIM), and the like. A device including an identification (ID) module (hereinafter referred to as an identification device) may be configured in the form of a smart card. Therefore, the ID device may be coupled to the mobile device 2800 through a port.

When the mobile device 2800 is connected to an external cradle, the interface unit 2870 may be used as a path through which the connected cradle supplies power to the mobile device 2800 or a path through which a variety of command signals input to the cradle by a user are transferred to the mobile device 2800. The various command signals or the power input from the cradle may function as a signal for enabling the user to perceive that the mobile terminal is correctly mounted in the cradle.

The controller 2880 generally controls the overall operation of the mobile device 2800. For example, the controller 2880 performs control and processing associated with voice communication, data communication, video communication, and the like. The controller 2880 may include a multimedia module 2881 for multimedia reproduction. The multimedia module 2881 may be installed at the interior or exterior of the controller 2880. The controller 2880, in particular, the multimedia module 2881, may include the encoding apparatus 100 and/or the decoding apparatus 200 described above.

The controller 2880 may perform pattern recognition processing so as to recognize handwriting input or drawing input performed on the touchscreen as text and images.

The power supply unit 2890 serves to supply power to each component by receiving external power or internal power under control of the controller 2880.

A variety of embodiments to be disclosed in the following description may be implemented in a computer or a computer-readable recording medium by means of software, hardware, or a combination thereof.

In the case of implementing the present invention by hardware, the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and electric units for implementing other functions, etc. In some cases, embodiments of the present invention may also be implemented as the controller 2880.

In the case of implementing the present invention by software, embodiments such as steps and functions to be disclosed in the present invention may be implemented by additional software modules. Each software module may perform one or more functions and operations to be disclosed in the present invention. Software code may be implemented as a software application written in suitable program languages. The software code may be stored in the memory 2860, and may be carried out by the controller 2880.

FIG. 29 is a block diagram illustrating a configuration of a digital device according to another embodiment.

Another example of the digital device 2900 may include a broadcast receiving unit 2905, an external device interface unit 2935, a storage unit 2940, a user input interface unit 2950, a controller 2970, and a display unit 2980, an audio output unit 2985, a power supply unit 2990, and a photographing unit (not shown). Here, the broadcast receiving unit 2905 may include at least one tuner 2910, a demodulation unit 2920, and a network interface unit 2930. However, in some cases, the broadcast receiving unit 2905 may include the tuner 2910 and the demodulation unit 2920 but may not include the network interface unit 2930, and vice versa. In addition, although not shown, the broadcast receiving unit 2905 may include a multiplexer to multiplex a signal demodulated by the demodulation unit 2920 through the tuner 2910 and a signal received through the network interface unit 2930. In addition, although not shown, the broadcast receiving unit 2905 may include a demultiplexer to demultiplex the multiplexed signal or demultiplex the demodulated signal or the signal that has passed through the network interface unit 2930.

The tuner 2910 receives an RF broadcast signal respective by tuning a channel selected by the user, among radio frequency (RF) broadcast signals received through an antenna or all previously stored channels. Also, the tuner 2910 converts the received RF broadcast signal to an intermediate frequency (IF) signal or a baseband signal.

For example, when the received RF broadcast signal is a digital broadcast signal, the tuner 2910 converts the received RF broadcast signal into a digital IF signal (DIF), and, when the received RF broadcast signal is an analog broadcast signal, the tuner 2910 converts the received RF broadcast signal into an analog baseband image or audio signal (CVBS/SIF). That is, the tuner 2910 may process both the digital broadcast signal and the analog broadcast signal. The analog baseband image or audio signal (CVBS/SIF) output from the tuner 2910 may be directly inputted to the controller 2970.

In addition, the tuner 2910 may receive an RF broadcast signal of a single carrier according to an advanced television system committee (ATSC) method or an RF broadcast signal of multiple carriers according to a digital video broadcasting (DVB) method.

Meanwhile, among the RS broadcast signals received through the antenna, the tuner 2910 may sequentially tunes and receives the RF broadcast signals of all stored broadcast channels using a channel memory function, and then, convert the received signals to intermediate frequency signals or baseband signals.

The demodulation unit 2920 receives and demodulates the digital IF signal DIF converted by the tuner 2910. For example, when the digital IF signal output from the tuner 2910 corresponds to an ATSC method, the demodulation unit 2920 performs, for example, 8-VSB (8-vestigal side band) demodulation. Also, the demodulator 2920 may perform channel decoding. To this end, the demodulation unit 2920 may include a trellis decoder, a deinterleaver, a Reed-Solomon decoder, and the like to perform trellis decoding, deinterleaving, and Reed Solomon decoding.

For example, when the digital IF signal output from the tuner 2910 corresponds to a DVB method, the demodulation unit 2920 performs, for example, coded orthogonal frequency division modulation (COFDMA) demodulation. Also, the demodulation unit 2920 may perform channel decoding. To this end, the demodulation unit 2920 may include a convolution decoder, a deinterleaver, a Reed-Solomon decoder, and the like to perform convolutional decoding, deinterleaving, and Reed-Solomon decoding.

The demodulation unit 2920 may output a stream signal TS after performing demodulation and channel decoding. In this case, the stream signal may be a signal in which an image signal, an audio signal, or a data signal is multiplexed. As an example, the stream signal may be an MPEG-2 transport stream (TS) in which an MPEG-2 standard image signal and a Dolby AC-3 standard audio signal are multiplexed. Specifically, the MPEG-2 TS may include a header of 4 bytes and a payload of 184 bytes.

Meanwhile, the demodulation unit 2920 described above may be separately provided according to the ATSC method and the DVB method. That is, the digital device may separately include an ATSC demodulation unit and a DVB demodulation unit.

The stream signal output from the demodulation unit 2920 may be input to the controller 2970. The controller 2970 may control demultiplexing, image/audio signal processing, and the like and may control output of an image through the display unit 2980 and a sound output through the audio output unit 2985.

The external device interface unit 2935 provides an environment so that various external devices are interfaced to the digital device 2900. To this end, the external device interface unit 2935 may include an A/V input/output unit (not shown) or a wireless communication unit (not shown).

The external device interface unit 2935 may be connected to an external device, such as a DVD (Digital Versatile Disk), a Blu-ray, a gaming device, a camcorder, a computer (notebook, tablet), a smartphone, a Bluetooth device, cloud, etc., in a wired/wireless manner. The external device interface unit 2935 transmits an image, audio, or data (including an image) signal input from the outside through a connected external device to the controller 2970 of a digital device. The controller 2970 may control the processed image, audio, or data signal to be output to a connected external device. To this end, the external device interface unit 2935 may further include an A/V input/output unit (not shown) or a wireless communication unit (not shown).

The A/V input/output unit may include a USB terminal, a CVBS (Composite Video Banking Sync) terminal, a component terminal, an S-video terminal (analog), a DVI (Digital Visual Interface) terminal, an HDMI (High Definition Multimedia Interface) terminal, an RGB terminal, a D-SUB terminal, and so on, to input image and audio signals of the external device to the digital device 2900.

The wireless communication unit may perform short-range wireless communication with another electronic device. The digital device 2900 may be connected another electronic device by a network according to communication protocols such as Bluetooth, radio frequency identification (RFID), infrared data association (IrDA), ultra wideband (UWB), ZigBee, digital living network alliance (DLNA), etc.

In addition, the external device interface unit 2935 may be connected to various set-top boxes through at least one of various terminals described above to perform input/output operations with the set-top-box.

Meanwhile, the external device interface unit 2935 may receive an application or an application list in an adjacent external device and transmit the received application or application list to the controller 2970 or the storage unit 2940.

The network interface unit 2930 provides an interface for connecting the digital device 2900 to a wired/wireless network including the Internet. The network interface unit 2930 may include, for example, an Ethernet terminal for connection with a wired network, and may use, for example, a wireless LAN (WLAN) (Wi-Fi), wireless broadband (Wibro), world interoperability for microwave access (Wimax), high speed downlink packet access (HSDPA) communication standards, and the like for connection with a wireless network.

The network interface unit 2930 may transmit or receive data with another user or another digital device through a connected network or another network linked to the connected network. In particular, the network interface unit 2930 may transmit part of content data stored in the digital device 2900 to a selected user or a selected digital device among previously registered other users or other digital devices.

Meanwhile, the network interface unit 2930 may access a predetermined web page through a connected network or another network linked to the connected network. That is, the network interface unit 2930 may transmit or receive data to or from a corresponding server by accessing a predetermined webpage through a network. In addition, the network interface unit 2930 may receive content or data provided by a content provider or network operator. That is, content such as movies, advertisements, games, VODs, broadcast signals, and related information provided from a content provider or a network provider may be received through a network. In addition, update information and an update file of firmware provided by a network operator may be received. Data may be transmitted to the Internet or content provider or network operator.

In addition, the network interface unit 2930 may selectively receive a desired application from among applications open to the public through a network.

The storage unit 2940 may store a program for processing and controlling each signal in the controller 2970 or may store a signal-processed video, audio, or data signal.

In addition, the storage unit 2940 may perform a function for temporary storage of a video, audio, or data signal input from the external device interface unit 2935 or the network interface unit 2930. The storage unit 2940 may store information on a predetermined broadcast channel through a channel memory function.

The storage unit 2940 may store an application or an application list input from the external device interface unit 2935 or the network interface unit 2930.

In addition, the storage unit 2940 may store various platforms, which will be described later.

The storage unit 2940 may include at least one type storage medium among, for example, a flash memory type, a hard disk type, a multimedia card micro type, a card type memory (e.g., SD or XD memory, etc.), RAM, and ROM (EEPROM, etc.). The digital device 2900 may reproduce and provide a content file (video file, still image file, music file, document file, application file, etc.) stored in the storage unit 2940 to a user.

FIG. 29 illustrates an embodiment in which the storage unit 2940 is provided separately from the controller 2970, but the scope of the present disclosure is not limited thereto. That is, the storage unit 2940 may be included in the controller 2970.

The user input interface unit 2950 transmits a signal input by the user to the controller 2970 or transmits a signal from the controller 2970 to the user.

For example, the user input interface unit 2950 may receive a control signal such as power on/off, channel selection, screen setting, etc., from a remote control device 3000 according to various communication methods such as an RF communication method and an infrared (IR) communication method and process the same or may transmit a control signal from the controller 2970 to the remote control device 3000.

In addition, the user input interface unit 2950 may transmit a control signal input from a local key (not shown) such as a power key, a channel key, a volume key, and a set value to the controller 2970.

The user input interface unit 2950 may transmit a control signal input from a sensing unit (not shown) for sensing a user's gesture to the controller 2970 or a signal from the controller 2970 to the sensing unit (not shown). Here, the sensing unit (not shown) may include a touch sensor, a voice sensor, a position sensor, and a motion sensor.

The controller 2970 may demultiplex a stream input through the tuner 2910, the demodulation unit 2920, or the external device interface unit 2935, or processes demultiplexed signals to generate and output a signal for image or sound output. The controller 2970 may include the encoding apparatus and/or decoding apparatus described above.

The image signal processed by the controller 2970 may be input to the display unit 2980 and displayed as an image corresponding to the corresponding image signal. In addition, the image signal processed by the controller 2970 may be input to an external output device through the external device interface unit 2935.

The audio signal processed by the controller 2970 may be output to the audio output unit 2985. Also, the audio signal processed by the controller 2970 may be input to an external output device through the external device interface unit 2935.

Although not shown in FIG. 29, the controller 2970 may include a demultiplexer, an image processing unit, and the like.

The controller 2970 may control an overall operation of the digital device 2900. For example, the controller 2970 may control the tuner 2910 to tune an RF broadcast corresponding to a channel selected by a user or a pre-stored channel.

The controller 2970 may control the digital device 2900 according to a user command input through the user input interface unit 2950 or an internal program. In particular, it is possible to access a network to download an application or an application list desired by the user into the digital device 2900.

For example, the controller 2970 controls the tuner 2910 to input a signal of a channel selected according to a predetermined channel selection command received through the user input interface unit 2950. Also, the controller 2970 processes a video, audio, or data signal of the selected channel. The controller 2970 enables channel information selected by the user to be output through the display unit 2980 or the audio output unit 2985 together with the processed image or audio signal.

As another example, the controller 2970 causes an image signal or an audio signal from an external device, e.g., a camera or a camcorder, input through an external device interface unit 2935 according to an external device image reproduction command received through the user input interface unit 2950, to be output through the display unit 2980 or the audio output unit 2985.

Meanwhile, the controller 2970 may control the display unit 2980 to display an image. For example, the controller 2970 may control the display 2980 to display a broadcast image input through the tuner 2910, an external input image input through the external device interface unit 2935, an image input through a network interface unit, or an image stored in the storage unit 2940. In this case, the image displayed on the display unit 2980 may be a still image or video and may be a 2D image or a 3D image.

In addition, the controller 2970 may control to reproduce content. The content here may be content stored in the digital device 2900, received broadcast content, or external input content input from the outside. The content may be at least one of a broadcast image, an external input image, an audio file, a still image, an accessed web screen, and a document file.

Meanwhile, when an application view item is entered, the controller 2970 may control to display an application or a list of applications that may be downloaded from the digital device 2900 or from an external network.

The controller 2970 may control to install and run an application downloaded from an external network in addition to various user interfaces. In addition, the controller 2970 may control an image related to an executed application to be displayed on the display unit 2880 according to the user's selection.

Meanwhile, although not shown in the drawing, a channel browsing processing unit for generating a thumbnail image corresponding to a channel signal or an external input signal may be further provided.

The channel browsing processing unit may receive a stream signal (TS) output from the demodulation unit 2920 or a stream signal output from the external device interface unit 2935, and extracts an image from the input stream signal to generate a thumbnail image.

The generated thumbnail image may be input to the controller 2970 as it is or may be coded and then input to the controller 2970. In addition, the generated thumbnail image may be encoded in the form of a stream and input to the controller 2970. The controller 2970 may display a thumbnail list including a plurality of thumbnail images on the display 2980 using the input thumbnail images. Meanwhile, the thumbnail images in the thumbnail list may be updated sequentially or simultaneously. Accordingly, the user may easily recognize the contents of a plurality of broadcast channels.

The display unit 2980 converts an image signal, a data signal, an OSD signal processed by the controller 2970 or an image signal and a data signal received from the external device interface unit 2935 into R, G, and B signals to generate a driving signal.

The display unit 2980 may be a PDP, an LCD, an OLED, a flexible display, a 3D display, or the like.

Meanwhile, the display unit 2980 may be configured as a touch screen and used as an input device as well as an output device.

The audio output unit 2985 receives a signal processed by the controller 2970, for example, a stereo signal, a 3.1 channel signal, or a 5.1 channel signal, and outputs the same as sound. The audio output unit 2985 may be implemented in various types of speakers.

Meanwhile, in order to detect a user's gesture, as described above, a sensing unit (not shown) including at least one of a touch sensor, a voice sensor, a position sensor, and a motion sensor may be further provided in the digital device 2900. A signal sensed by the sensing unit (not shown) may be transmitted to the controller 2970 through the user input interface unit 2950.

Meanwhile, a photographing unit (not shown) for photographing the user may be further provided. Image information captured by the photographing unit (not shown) may be input to the controller 2970.

The controller 2970 may detect a user's gesture based on an image photographed from the photographing unit (not shown) or a signal sensed from the sensing unit (not shown) separately or in combination.

The power supply unit 2990 supplies corresponding power to the entire digital device 2900.

In particular, the power supply unit 2990 may supply power to the controller 2970 that may be implemented in the form of a system on chip (SOC), the display unit 2980 for displaying an image, and the audio output unit 2985 for outputting audio.

To this end, the power supply unit 2990 may include a converter (not shown) for converting AC power into DC power. Meanwhile, for example, when the display unit 2980 is implemented as a liquid crystal panel having a plurality of backlight lamps, an inverter (not shown) capable of PWM operation may be further provided for luminance varying or dimming driving.

The remote control device 3000 transmits a user input to the user input interface unit 2950. To this end, the remote control device 3000 may use Bluetooth, radio frequency (RF) communication, infrared (IR) communication, ultra wideband (UWB), ZigBee, or the like.

In addition, the remote control device 3000 may receive an image, audio, or data signal output from the user input interface unit 2950, and displays the same on the remote control device 3000 or output a voice or vibration.

The digital device 2900 described above may be a digital broadcast receiver capable of processing a digital broadcast signal of a fixed or mobile ATSC or DVB method.

In addition, the digital device according to the present disclosure may omit some of the illustrated components as necessary or may further include a component not illustrated. Meanwhile, unlike the case described above, the digital device may not include a tuner and a demodulator and may receive and play content through a network interface unit or an external device interface unit.

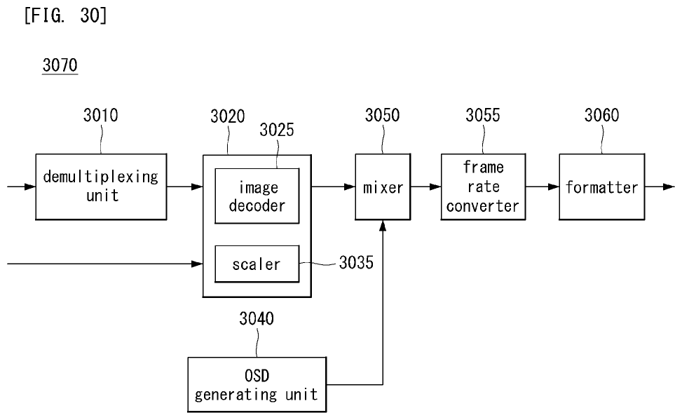

FIG. 30 is a block diagram illustrating a detailed configuration of the controller of FIGS. 27 to 29 according to an embodiment.

An example of THE controller may include a demultiplexing unit 3010, an image processing unit 3020, an on-screen display (OSD) generating unit 3040, a mixer 3050, and a frame rate converter (FRC) 3055, and a formatter 3060. In addition, although not shown, the controller may further include a voice processing unit and a data processing unit.

The demultiplexing unit 3010 demultiplexes an input stream. For example, the demultiplexing unit 3010 may demultiplex input MPEG-2 TS video, audio, and data signals. Here, the stream signal input to the demultiplexing unit 3010 may be a stream signal output from a tuner, a demodulating unit, or an external device interface unit.

The image processing unit 3020 performs image processing on the demultiplexed image signal. To this end, the image processing unit 3020 may include an image decoder 3025 and a scaler 3035.

The image decoder 3025 decodes the demultiplexed image signal, and the scaler 3035 scales resolution of the decoded image signal to be output from the display unit.

The image decoder 3025 may support various standards. For example, the image decoder 3025 may function as an MPEG-2 decoder when an image signal is encoded in the MPEG-2 standard, and may function as an H.264 decoder when an image signal is encoded in a DMB method or H.264 standard.

Meanwhile, the image signal decoded by the image processing unit 3020 is input to the mixer 3050.

The OSD generating unit 3040 generates OSD data by itself or according to a user input. For example, the OSD generating unit 3040 generates data for displaying various data on the screen of the display unit in the form of a graphic or text based on a control signal from the user input interface unit. The generated OSD data includes various data such as a user interface screen of a digital device, various menu screens, widgets, icons, and viewing rate information.

The OSD generating unit 3040 may generate data for displaying a caption of a broadcast image or broadcast information based on EPG.

The mixer 3050 mixes the OSD data generated by the OSD generating unit 3040 and the image signal processed by the image processing unit and provides a mixture to the formatter 3060. Since the decoded image signal and OSD data are mixed, the OSD is displayed as an overlay on a broadcast image or an external input image.

The frame rate converter (FRC) 3055 converts a frame rate of an input image. For example, the frame rate converter 3055 may convert an input 60 Hz image to have a frame rate of, for example, 120 Hz or 240 Hz according to an output frequency of the display unit. As described above, there may be various methods for converting the frame rate. For example, in the case of converting the frame rate from 60 Hz to 120 Hz, the frame rate converter 3055 may converting the frame rate by inserting the same first frame between the first frame and a second frame or by inserting a third frame predicted from the first frame and the second frame. As another example, in the case of converting the frame rate from 60 Hz to 240 Hz, the frame rate converter 3055 may convert the frame rate by inserting three more identical frames or predicted frames between existing frames. Meanwhile, when a separate frame conversion is not performed, the frame rate converter 3055 may be bypassed.

The formatter 3060 changes an output of the input frame rate converter 3055 according to an output format of the display unit. For example, the formatter 3060 may output R, G, B data signals, and these R, G, B data signals may be output as low voltage differential signaling (LVDS) or mini-LVDS. In addition, when an output of the input frame rate converter 3055 is a 3D image signal, the formatter 3060 may support 3D service through the display unit by configuring and outputting in a 3D format suitable for an output format of the display unit.

Meanwhile, an audio processing unit (not shown) in the controller may perform audio processing of a demultiplexed audio signal. Such an audio processing unit (not shown) may support processing various audio formats. For example, even when an audio signal is encoded in a format such as MPEG-2, MPEG-4, AAC, HE-AAC, AC-3, BSAC, a decoder corresponding thereto may be provided to process the corresponding signal.

In addition, the audio processing unit (not shown) in the controller may process a base, a treble, a volume control, and the like.

A data processing unit (not shown) in the controller may perform data processing of a demultiplexed data signal. For example, the data processing unit may decode even a signal encoded from a demultiplexed data signal. Here, the encoded data signal may be EPG information including broadcast information such as a start time and an end time of a broadcast program aired on each channel.

Meanwhile, the aforementioned digital device is an example according to the present disclosure, and each component may be integrated, added, or omitted according to specifications of the digital device that is actually implemented. That is, if necessary, two or more components may be combined into one component or one component may be subdivided into two or more components. In addition, functions performed by each block are for explaining an embodiment of the present disclosure, and specific operations or devices thereof do not limit the scope of the present disclosure.

Meanwhile, the digital device may be an image signal processing device that performs signal processing of an image stored in the device or an input image. Other examples of the image signal processing device include a set-top-box (STB) excluding the display unit 2980 and the audio output unit 2985 shown in FIG. 29, the aforementioned DVD player, Blu-ray player, game device, and computer.

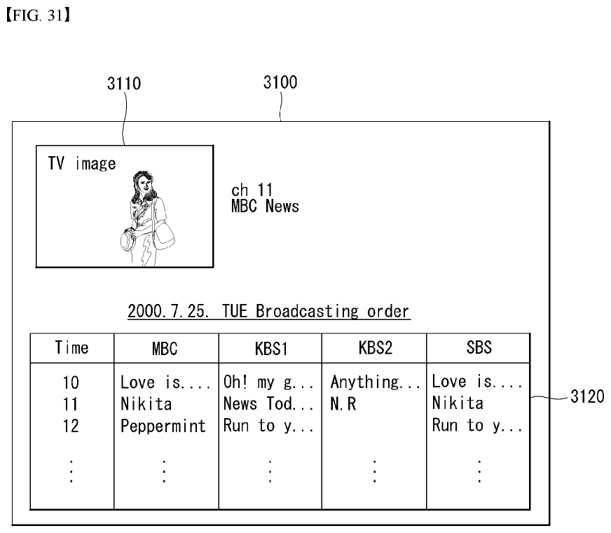

FIG. 31 is a diagram illustrating an example in which a screen of a digital device according to an embodiment simultaneously displays a main image and a sub-image.

The digital device according to an embodiment may simultaneously display A main image 3110 and the sub-image 3120 on the screen 3100. The main image 3110 may be referred to as a first image, and the sub-image 3120 may be referred to as a second image. The main image 3110 and the sub-image 3120 may include a moving picture, a still image, an electronic program guide (EPG), a graphical user interface (GUI), an on-screen display (OSD), and the like, but are not limited thereto. The main image 3110 may refer to an image that is displayed simultaneously with the sub-image 3120 on a screen 3100 of the electronic device and has a size relatively smaller than that of the screen 3100 of the electronic device, and may be referred to as a picture-in-picture (PIPI). In FIG. 30, the main image 3110 is shown to be displayed on the upper left of the screen 3100 of the digital device, but a position where the main image 3110 is displayed is not limited thereto, and the main image 3110 may be displayed at any location within the screen 3100 of the digital device.

The main image 3110 and the sub-image 3120 may be directly or indirectly related to each other. As an example, the main image 3110 may be a streaming video, and the sub-image 3120 may be a GUI that sequentially displays thumbnails of videos including information similar to the streaming video. As another example, the main image 3110 may be a broadcasted image, and the sub-image 3120 may be an EPG. As another example, the main image 3110 may be a broadcast image, and the sub-image 3120 may be a GUI. Examples of the main image 3110 and the sub-image 3120 are not limited thereto.

In an embodiment, the main image 3110 may be a broadcast image received through a broadcast channel, and the sub-image 3120 may be information related to a broadcast image received through a broadcast channel. The information related to the broadcast image received through the broadcast channel may include, for example, EPG information including a comprehensive channel schedule, detailed broadcast program information, and broadcast program replay information, but is not limited thereto.

In another embodiment, the main image 3110 may be a broadcast image received through a broadcast channel, and the sub-image 3120 may be an image generated based on information previously stored in a digital device. An image generated based on information previously stored in a digital device may include, for example, a basic user interface (UI) of an EPG, basic channel information, an image resolution manipulation UI, a sleep reservation UI, and the like, and is limited thereto.

In another embodiment, the main image 3110 may be a broadcast image received through a broadcast channel, and the sub-image 3120 may be information related to a broadcast image received through a network. Information related to a broadcast image received through a network may be information obtained through a network-based search engine, for example. More specifically, for example, information related to a character currently displayed on the main image 3110 may be obtained through a network-based search engine.

However, examples are not limited thereto, and information related to broadcast images received through a network may be obtained, for example, by using an artificial intelligence (AI) system. More specifically, for example, an estimated location in a map of a place being displayed on the main image 3110 may be obtained using deep-learning based on a network, and the device may receive information on the estimated location on the map of the location being displayed on the main image 3110 through a network.

The digital device according to an embodiment may receive at least one of image information of the main image 3110 and image information of the sub-image 3120 from the outside. The image information of the main image 3110 may include, for example, a broadcast signal received through a broadcast channel, source code information of the main image 3110, an IP packet (internet protocol packet) of the main image 3110 received through a network, but is not limited thereto. Similarly, the image information of the sub-image 3120 may include, for example, a broadcast signal received through a broadcast channel, source code information of the sub-image 3120, IP packet information of the sub-image 3120 received through a network, etc., but is not limited thereto. The digital device may decode and use the image information of the main image 3110 or the image information of the sub-image 3120 received from the outside. However, in some cases, the digital device may internally store the image information of the main image 3110 or the image information of the sub-image 3120.

The digital device may display the main image 3110 and the sub-image 3120 on the screen 3100 of the digital device based on the image information of the main image 3110 and information related to the sub-image 3120.

In an example, the decoding apparatus 200 of the digital device includes a main image decoding apparatus and an sub-image decoding apparatus, and the main image decoding apparatus and the sub-image decoding apparatus may decode image information of the main image 3110 and image information of the sub-image 3120, respectively. A renderer may include a main image renderer (first renderer) and a sub-image renderer (second renderer), and the main image renderer may display the main image 3110 in a first region of the screen 3110 of the digital device based on information decoded by the main image decoding apparatus, and the sub-image renderer may display the sub-image 3120 in a second area of the screen 3100 of the digital device based on information decoded by the sub-image decoding apparatus.

In another example, the decoding apparatus 200 of the digital device may decode the image information of the main image 3110 and the image information of the sub-image 3120. Based on the information decoded by the decoding apparatus 200, a renderer may process the main image 3110 and the sub-image 3120 together so that the main image 3110 and the sub-image 3120 may be simultaneously displayed on the screen 3100 of the digital device.

That is, according to this document, the digital device may provide an image service processing method. The image service processing method may include receiving image information, decoding a (main) image based on the image information, rendering or displaying the decoded image in a first region of a display, and rendering or displaying a sub-image in a second region of the display. In this case, the decoding of the first image may follow a decoding procedure in the decoding apparatus 200 shown in FIG. 3 described above. The decoding of the first image may include deriving prediction samples for a current block based on inter or intra prediction, deriving residual samples for the current block based on received residual information (which can be omitted), and generating reconstructed samples based on the prediction samples and/or residual samples. The decoding of the first image may further include performing an in-loop filtering procedure on a reconstructed picture including the reconstructed samples.

For example, the sub-image may be an electronic program guide (EPG), an on screen display (OSD), or a graphic user interface (GUI). For example, the image information may be received through a broadcast network, and the information on the sub-image may be received through the broadcast network. For example, the image information may be received through a communication network, and information on the sub-image may be received through the communication network. For example, the image information may be received through a broadcast network, and information on the sub-image may be received through a communication network. For example, the image information may be received through a broadcast network or a communication network, and information on the sub-image may be stored in a storage medium of the digital device.

The embodiments described above are combinations of elements and features of the present disclosure in a predetermined form. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It will be obvious that claims that do not explicitly cite each other in the appended claims may be presented in combination as an embodiment of the present disclosure or included as a new claim by subsequent amendment after the application is filed.

In the case of implementation by firmware or software, the embodiment of the present disclosure may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present disclosure may be embodied in other specific forms without departing from essential characteristics of the present disclosure. Accordingly, the aforementioned detailed description should not be construed as restrictive in all terms and should be exemplarily considered. The scope of the present disclosure should be determined by rational construing of the appended claims and all modifications within an equivalent scope of the present disclosure are included in the scope of the present disclosure.

### INDUSTRIAL APPLICABILITY

Hereinabove, the preferred embodiments of the present disclosure are disclosed for an illustrative purpose and hereinafter, modifications, changes, substitutions, or additions of various other embodiments will be made within the technical spirit and the technical scope of the present disclosure disclosed in the appended claims by those skilled in the art.

1. A method of processing an image signal, the method comprising:
generating a merge candidate list including a plurality of motion vectors derived from a spatial merge candidate or a temporal merge candidate of a current block;
adding an additional motion vector determined as an average value of the motion vectors to the merge candidate list when a number of merge candidates of the merge candidate list is smaller than a maximum number of merge candidates; and
generating a prediction sample of the current block using a motion vector indicated by a merge index on the merge candidate list.

2. The method of claim 1, wherein the adding of the additional motion vector to the merge candidate list comprises adding, as the additional motion vector, an average value of a first motion vector corresponding to a first index and a second motion vector corresponding to a second index to the merge candidate list.

3. The method of claim 1, wherein the generating of the merge candidate list comprises: performing searching on a motion vector for the temporal merge candidate after searching a motion vector for the spatial merge candidate.

4. The method of claim 3, wherein the searching of the motion vector for the spatial merge candidate is performed in order of a left block, an upper block, an upper right block, a lower left block, and an upper left block of the current block.

5. The method of claim 1, further comprising:
adding a zero motion vector to the merge candidate list when the number of merge candidates of the merge candidate list to which the additional motion vector is added is smaller than the maximum number of merge candidates.

6. The method of claim 1, wherein the motion vectors refer to the same reference picture.

7. The method of claim 6, wherein the additional motion vector refers to the reference picture equally referred to by the motion vectors.

8. An apparatus for decoding an image signal, the apparatus comprising:
a memory configured to store the image signal; and
a processor coupled to the memory,
wherein the processor is configured
to generate a merge candidate list including a plurality of motion vectors derived from a spatial merge candidate or a temporal merge candidate of a current block,
to add an additional motion vector determined as an average value of the motion vectors to the merge candidate list when a number of merge candidates of the merge candidate list is smaller than a maximum number of merge candidates, and
to generate a prediction sample of the current block using a motion vector indicated by a merge index on the merge candidate list.

9. The apparatus of claim 8, wherein the processor is configured to add, as the additional motion vector, an average value of a first motion vector corresponding to a first index and a second motion vector corresponding to a second index to the merge candidate list.

10. The apparatus of claim 8, wherein the processor is configured to perform searching on a motion vector for the temporal merge candidate after searching a motion vector for the spatial merge candidate.

11. The apparatus of claim 10, wherein the searching of the motion vector for the spatial merge candidate is performed in order of a left block, an upper block, an upper right block, a lower left block, and an upper left block of the current block.

12. The apparatus of claim 8, wherein the processor is configured to add a zero motion vector to the merge candidate list when the number of merge candidates of the merge candidate list to which the additional motion vector is added is smaller than the maximum number of merge candidates.

13. The apparatus of claim 8, wherein the motion vectors refer to the same reference picture.

14. The apparatus of claim 13, wherein the additional vector refers to the reference picture equally referred to by the motion vectors.
